(19) United States
(12) Patent Application Publication
(10) Pub. No.: US 2009/0078583 A1
(43) Pub. Date: Mar. 26, 2009

(54) Electrochemical mechanical polishing method and electrochemical mechanical polishing apparatus

(76) Inventors: Itsuki Kobata, Tokyo (JP); Akira Kodera, Kanagawa-ken (JP); Yasushi Toma, Kanagawa-ken (JP); Tsukuru Suzuki, Kanagawa-ken (JP); Takayuki Saito, Kanagawa-ken (JP); Yuji Makita, Kanagawa-ken (JP); Hirokuni Hiyama, Kanagawa-ken (JP)

Correspondence Address: WENDEROTH, LIND & PONACK, L.L.P., 2033 K STREET N. W., SUITE 800, WASHINGTON, DC, 20006-1021, US

(21) Appl. No.: 12/007,956

(22) Filed: Jan. 17, 2008

(30) Foreign Application Priority Data
Jan. 22, 2007 (JP) 2007-011767
Oct. 23, 2007 (JP) 2007-275684

(51) Int. Cl. B23H 5/06; B23H 11/00; C25F 3/16; C25F 7/00

(52) U.S. Cl. 205/641; 205/662; 204/228.7; 204/275.1; 205/645

(57) ABSTRACT

A composite electrolytic processing method makes it possible to remove a conductive film without leaving it in an electrically-insulated state on an underlying barrier film, thereby exposing the barrier film. The electrochemical mechanical polishing method includes: applying a voltage between a first electrode connected to one pole of a power source and a second electrode, connected to the other pole of the power source, for feeding electricity to a conductive film of a polishing object; filling an electrolytic liquid into a space between the first electrode and the conductive film of the polishing object; and pressing and rubbing the conductive film against a polishing surface of a polishing pad to polish the conductive film in such a manner that a barrier film underlying the conductive film becomes gradually exposed from the center toward the periphery of the polishing object.

### BACKGROUND OF THE INVENTION

1. Field of the Invention

The present invention relates to an electrochemical mechanical polishing method and an electrochemical mechanical polishing apparatus, and more particularly to an electrochemical mechanical polishing method and an electrochemical mechanical polishing apparatus for use in carrying out processing of a conductive material on a surface of a substrate, such as a semiconductor wafer.

2. Description of the Related Art

A so-called damascene process is a process of embedding an interconnect metal into interconnect recesses, such as trenches and via holes, formed in an insulating film. This damascene process is increasingly used for forming interconnects in a semiconductor device. The damascene process is performed generally as follows. First, interconnect recesses are formed in an insulating film (interlevel dielectric film), which is composed of SiO₂, SiOF, SiOC, a so-called Low-k material, or the like, on a substrate, Subsequently, a barrier film of titanium, tantalum, tungsten, ruthenium, and/or an alloy thereof, is formed on a surface of the insulating film in its entirety including the interconnect recesses. Then, an interconnect metal film of aluminum, copper, silver, gold, tungsten, or an alloy thereof, is formed on a surface of the barrier film to fill the interconnect recesses with interconnect metal. Thereafter, an extra interconnect metal film and the barrier film formed on portions other than the interconnect recesses are removed. In current high-speed devices, copper or copper alloy is generally used as the interconnect metal, and the Low-k material is increasingly used for the insulating film.

In a damascene process, in many cases, interconnect recesses are formed by dry etching or the like, and a barrier film is formed by a dry process, such as PVD, CVD or ALD. An interconnect metal film may be formed by a wet process, such as electroplating or electroless plating, or a dry process, such as PVD, CVD or ALD. Of these, electroplating is widely practiced. When forming an interconnect metal film by electroplating on a barrier film which has a low electric conductivity, it is a common practice to previously form a feeding seed film on a surface of the barrier film subsequent to the formation of the barrier film. The removal of an extra interconnect metal film and a barrier film is generally carried out by a so-called flattening process, such as chemical mechanical polishing (CMP), electrolytic polishing or electrochemical mechanical polishing. With reference to electrochemical mechanical polishing, the progress of polishing is considered to be based on the following mechanism: (1) electrolytic oxidation of an interconnect metal; (2) complexation of the oxidized interconnect metal by a component of an electrolytic liquid; and (3) mechanical removal of the interconnect metal complex.

FIG. 1A through FIG. 1C are diagrams illustrating a sequence of process of forming copper interconnects for a semiconductor device. As shown in FIG. 1A, an insulating film (interlevel dielectric film) 302, such as a film of SiO₂ or Low-k material, is deposited on a conductive layer 301a formed on a semiconductor base 301 having formed semiconductor devices. Via holes 303 and trenches 304 are formed in the insulating film 302 using a lithography etching technique, for example. Thereafter, a barrier film 305 of Ta, TaN, or the like is formed on the insulating film 302, and a seed film 306, serving as an electric supply film for electroplating, is formed on the barrier film 305 by sputtering or the like.

Then, as shown in FIG. 1B, copper plating is performed on a surface of a semiconductor substrate W to fill the via holes 303 and the trenches 304 with copper and, at the same time, to deposit a copper film 307 as an interconnect metal film on the insulating film 302. Thereafter, polishing, such as chemical mechanical polishing (CMP), is performed so as to remove the copper film 307, the seed film 306, and the barrier film 305 on the insulating film 302 until a surface of the copper film 307, filling the via holes 303 and the trenches 904, lies substantially in the same plane as a surface of the insulating film 302. Interconnects 308, composed of the seed film 306 and the copper film 307, are thus formed in the insulating film 302, as shown in FIG. 1C.

With the progress toward lower dielectric constant of an interlevel dielectric film, a low-k material has been put into practical use for an interlevel dielectric film in a process for the formation of interconnects of a semiconductor device. As a consequence, decreasing damage to a film of low-k material, such as breakage or peel off of the film, during polishing has become a significant problem. One solution to solve the problem is to use a lower polishing pressure. In polishing of a semiconductor wafer as typically carried out by CMP, uniformity of polishing rate in the wafer surface has heretofore been ensured primarily by regulating the polishing pressure to make it uniform in the wafer surface or by making the relative speed between the wafer and a polishing pad uniform during polishing.

FIG. 2 shows polishing pressure-dependency of polishing rate in common CMP. As shown in FIG. 2, polishing rate rapidly increases with an increase in polishing pressure in a low-polishing pressure region. The polishing rate curve, however, generally has an inflection point, and the increase in polishing rate becomes smaller when the polishing rate exceeds the inflection point. Conventional polishing has been practiced at a high polishing rate (i.e., with a small increase in polishing rate with an increase in polishing pressure) with the polishing pressure uniform over a wafer surface, using a polishing pressure (e.g., 2-3 psi) that is somewhat higher than that of the inflection point shown in FIG. 2.

In the low-polishing pressure region [not more than 1.0 psi (70 hPa)], on the other hand, because of the large increase in polishing rate with an increase in polishing pressure, (1) a large lowering of polishing rate and (2) a large change in polishing rate with a slight change in polishing pressure become problems. Therefore, to overcome these problems leads to realization of low-pressure polishing. Electrochemical mechanical polishing, which utilizes an electrolytic action in combination with mechanical polishing, offers a solution to the problems. Electrochemical mechanical polishing is characterized in that polishing rate increases with an applied voltage under constant polishing pressure conditions, which may enable high-speed polishing at a low polishing pressure.

Further, it has been proposed to produce a distribution of applied voltage in a wafer surface during polishing in order to ensure the uniformity of polishing rate in the wafer surface (see Japanese Patent Laid-Open Publications Nos. 2003-193300 and 2003-278000 and U.S. Pat. No. 6,848,970).

FIG. 3 shows a cross section of a substrate which has undergone the processing of forming interconnect recesses 63, such as trenches and contact holes, in an insulating film (interlevel dielectric film) 62 of a so-called low-k material, forming a barrier film 64 of, e.g., titanium nitride on an entire surface, including the interconnect recesses 63, of the insulating film 62, and forming a conductive film 66 of, e.g., tungsten on a surface of the barrier film 64, thereby filling a metal interconnect material (conductive film 66), e.g., tungsten, into the interconnect recesses 63. In this case, recesses 67, reflecting the configurations of the recesses 63, are formed in the surface of the conductive film 66. Thereafter, an extra conductive film 66 and barrier film 64, formed outside the interconnect recesses 63, are removed to form interconnects of, e.g., tungsten.

Chemical mechanical polishing (CMP) is generally employed for the removal of the conductive film 66 of, e.g., tungsten. As shown in FIG. 4, CMP is carried out by moving a substrate W and a polishing pad 601 relative to each other while pressing a surface of the substrate W on the polishing pad 601 and supplying a slurry 652 to a surface conductive film of the substrate W (see Doi, “Explication of Semiconductor CMP Technology”, Kogyo Chosakai Publishing, Inc., December 2000, pp. 277-284). The slurry 652 generally contains abrasive grains and an oxidizing agent. A tungsten oxide film is formed by the oxidizing agent in the surface of the conductive film 66 shown in FIG. 3. The tungsten oxide film formed in the high portions H (outside the recesses 67) of the conductive film 66 is removed by contact with the polishing pad, and thus the conductive film 66 in the high portions H is polished. On the other hand, the tungsten oxide film formed in the low portions L (inside the recesses 67) of the conductive film 66 does not come into contact with the polishing pad and is not removed, and thus the conductive film 66 in the low portions L is not polished. The surface level difference (recesses 67) of the conductive film 66 is thus eliminated.

### SUMMARY OF THE INVENTION

When polishing a conductive film on a polishing object, for example, an interconnect metal film of copper on a substrate, by electrochemical mechanical polishing to expose a barrier film, if the conductive film remains on the barrier film in an electrically-insulated state, the above-described (1) electrolytic oxidation of interconnect metal (conductive film), one of the factors for the above-described mechanism of electrochemical mechanical polishing, becomes impossible. Accordingly, electrolytic polishing of the conductive film, remaining in an electrically-insulated state on the barrier film, will not proceed any more. If the next process of polishing of the barrier film is carried out with the conductive film left as it is, polishing of the barrier film will be non-uniform due to the remaining conductive film, which may result in the barrier film, to be removed, being left unremoved, or an increase in dishing or erosion due to excessive polishing of the conductive film (interconnect metal). Therefore, when removing a conductive film on a barrier film by electrochemical mechanical polishing to expose the barrier film, it is required not to leave the conductive film in an electrically-insulated state on the barrier film during polishing.

The above-described CMP process for polishing tungsten, on the other hand, utilizes the mechanism of forming a tungsten oxide film having a considerable thickness by the use of an acidic slurry having a pH<4, and mechanically polishing the tungsten oxide film. The CMP process therefore involves the problem of low polishing rate. The use of a slurry containing abrasive grains in a high concentration and the use of a high polishing pressure are needed in order to increase the polishing rate. This, however, involves the problem that damage, such as scratches, and dishing (excessive polishing of conductive film) are likely to occur in the surface of the conductive film and, in addition, the problem that an insulating film, which should not be polished, can be polished, which may cause erosion (excessive polishing of the insulating film).

The present invention is made in view of the above situation. It is therefore a first object of the present invention to provide a composite electrolytic processing method and a composite electrolytic processing apparatus which make it possible to remove a conductive film without leaving it in an electrically-insulated state on an underlying barrier film, thereby exposing the barrier film.

It is a second object of the present invention to provide a composite electrolytic processing method which can quickly remove a conductive film, lying outside an area for forming contact plugs or interconnects, while preventing excessive polishing such as dishing or erosion.

In order to achieve the above first object, the present invention provides an electrochemical mechanical polishing method comprising: applying a voltage between a first electrode connected to one pole of a power source and a second electrode, connected to the other pole of the power source, for feeding electricity to a conductive film of a polishing object; filling an electrolytic liquid into a space between the first electrode and the conductive film of the polishing object; and pressing and rubbing the conductive film against a polishing surface of a polishing pad to polish the conductive film in such a manner that a barrier film underlying the conductive film becomes gradually exposed from the center toward the periphery of the polishing object.

By thus polishing the conductive film in such a manner that the barrier film underlying the conductive film becomes gradually exposed from the center toward the periphery of the polishing object, the conductive film can be prevented from remaining in an electrically-insulated state on the barrier film without being polished away during polishing.

Preferably, the conductive film is polished so that the average thickness of the remaining conductive film becomes not more than 300 nm, and the thickness distribution of the remaining conductive film in the polishing object becomes not more than 150 nm.

For example, it is possible to first polish the conductive film flatly until the average thickness of the remaining conductive film becomes not more than 300 nm, and then polish the remaining conductive film by applying a larger polishing pressure on the central portion of the polishing object and a lower polishing pressure on the peripheral portion, thereby polishing away the conductive film preferentially from the central portion of the polishing object. The thickness of the conductive film, remaining on the peripheral portion of the polishing object upon removal of the conductive film from the central portion of the polishing object, is, e.g., not more than 100 nm, preferably not more than 50 nm, more preferably not more than 20 nm. This can shorten a period of time during which the conductive film, such as an interconnect metal film, is exposed to an electrolytic liquid, thereby preventing excessive polishing of the conductive film (interconnect metal film) embedded, e.g., in trenches.

The conductive film may be polished so that the average thickness of the remaining conductive film becomes not more Man 300 nm, and the thickness of the remaining conductive film in the polishing object increases with distance from the center of the polishing object.

It is possible to first polish the conductive film so that the thickness of the remaining film in the polishing object increases with distance from the center of the polishing object, and then polish the remaining conductive film at a uniform rate. The difference in the thickness of the conductive film remaining upon termination of the polishing is, for example, not more than 100 nm, preferably not more than 50 nm, more preferably not more than 20 nm.

Polishing may be carried out under such conditions that the polishing rate decreases with distance from the center of the polishing object.

The barrier film can be exposed gradually from the center toward the periphery by carrying out polishing under such conditions that the polishing rate decreases with distance from the center of the polishing object. The difference in polishing rate during the polishing is, for example, 100 nm/min and preferably not more than 50 nm/min.

When the barrier film becomes gradually exposed from the center toward the periphery of the polishing object, the electrolytic etching rate of the conductive film is preferably not more than 50 nm/min.

The electrolytic etching rate refers to the rate of etching as carried out by applying an electric potential to a conductive film in an electrolytic liquid without mechanical polishing involved. In view of the fact that dishing at a level of at most 20 nm will be required in the future for a metal film of an interconnect portion in conjunction with the fact that the period from the beginning of exposure of a barrier film until the completion of exposure of the film is about 20 seconds in common CMP, a polishing rate of not more than 50 nm/min could achieve dishing at a level of at most 20 nm. By thus carrying out polishing of a conductive film, such as an interconnect metal film, at an electrolytic etching rate of not more than 50 nm/min, excessive polishing of the conductive film (interconnect metal film) embedded, e.g., in trenches, due to its exposure to an electrolytic liquid, can be prevented.

Preferably, the polishing rate of the remaining conductive film in the period of time when the average thickness of that film is not more than 200 nm, is not more than ½ of the polishing rate of the conductive film in the period of time when the average thickness of that film is not less than 200 nm.

This can also prevent excessive polishing of the conductive film (interconnect metal film) embedded, e.g., in trenches when the interconnect material film is used as the conductive film.

Two or more types of electrolytic liquids may be used in the polishing of the conductive film.

By switching the components of electrolytic liquid when the film(s) becomes a certain state (for example, when the thickness of the conductive film becomes 30 nm or when the barrier film becomes exposed) during polishing of the conductive film, it becomes possible to suppress electrolytic etching upon the begging of exposure of the barrier film and to increase the efficiency of removal of the conductive film after the beginning of exposure of the barrier film.

In a preferred aspect of the present invention, the conductive film is composed of copper or a copper alloy, and the pH of the electrolytic liquid is in a pH range, as specified in a copper potential-pH diagram, in which a passive oxide film is formed in copper.

Excessive electrolytic etching of the conductive film can be prevented by forming a passive oxide film on the surface of the conductive film and covering the conductive film with the passive oxide film.

An example of the electrolytic liquid contains 2 to 80% by weight of at least one organic acid, 2 to 20% by weight of at least one strong acid having a sulfonic acid group, 0.01 to 1% by weight of a corrosion inhibitor, 0.01 to 1% by weight of a water-soluble polymeric compound, 0.01 to 2% by weight of abrasive grains, and 0.01 to 1% by weight of a surfactant, and has a pH adjusted to 3 to 6, preferably 3 to 4.5.

Examples of the organic acid include acetic acid, propionic acid, oxalic acid, malonic acid, succinic acid, glutaric acid, adipic acid, maleic acid, fumaric acid, citric acid, aconitic acid, glyoxylic acid, glycolic acid, lactic acid, gluconic acid, malic acid and tartaric acid. Examples of the strong acid having a sulfonic acid group include benzenesulfonic acid, methanesulfonic acid, taurine, cysteic acid, an alkylbenzene sulfonic acid having 1 to 6 carbons in the alkyl group, trifluoromethanesulfonic acid and fluorosulfonic acid.

Examples of the corrosion inhibitor include benzotriazole and its derivatives. Examples of the water-soluble polymeric compound include polyethylene glycol, polyisopropyl acrylamide, polydimethyl acrylamide, polymethacrylamide, polymethoxyethylene, polyvinyl alcohol, hydroxyethyl cellulose, carboxymethyl cellulose, polyacrylic acid or a salt thereof, polymethacrylic acid or a salt thereof, and polyvinylpyrrolidone. Examples of the abrasive grains include those of colloidal silica or fumed silica, having a primary particle size of not less than 10 nm.

The electrolytic liquid may also be a common CMP slurry to which an electrolyte is added. Such an electrolytic liquid utilizes the chemical action of a common CMP slurry on a conductive film. The addition of an electrolyte to a common CMP slurry can increase the electric conductivity of the electrolytic liquid and can add to the chemical action of the CMP slurry. An organic acid, such as succinic acid, may be used as the electrolyte. Succinic acid, for example, is added to a CMP slurry. The pH of the electrolytic liquid may be adjusted to, e.g., 5.5 by using, e.g., KOH as a pH adjuster. When the electrolytic liquid having the adjusted pH is used and an applied voltage is changed, a passive film (passive oxide film) formation zone, as shown by “A” in FIG. 17, appears in the graph of FIG. 17 in the electrode potential range of 0.8 to 1.2 (V vs. Ag/AgCl).

Examples of the organic acid, other than succinic acid, include maleic acid, citric acid, glycolic acid, acetic acid, propionic acid, oxalic acid, malonic acid, glutaric acid, adipic acid, fumaric acid, aconitic acid, glyoxylic acid, lactic acid, gluconic acid, malic acid and tartaric acid.

By using an electrolytic liquid as described above and lowering the polishing rate (e.g., by lowering applied voltage), a passive oxide film can be formed on the surface of a conductive film, thereby preventing excessive electrolytic etching of the conductive film.

In a preferred aspect of the present invention, the voltage applied between the first electrode and the second electrode when the average thickness of the remaining conductive film is not more than 200 nm, is lower than the voltage applied between the first electrode and the second electrode when the average thickness of the remaining conductive film is not less than 200 nm.

This can also form a passive film on the surface of the conductive film during polishing when the average thickness of the conductive film is not less than 200 nm, thereby preventing excessive electrolytic etching of the conductive film.

The voltage applied between the first electrode and the second electrode in the period from the beginning to the completion of exposure of the barrier film may be not more than the corrosion potential of the conductive film in the electrode potential.

This can suppress corrosion of the conductive film, thereby preventing excessive polishing of the conductive film (interconnect metal film) embedded, e.g., in trenches.

The waveform of the voltage applied between the first electrode and the second electrode in the period from the beginning to the completion of exposure of the barrier film is, for example, a rectangular waveform, a sine waveform, or a ramp waveform.

The use of a waveform with a temporary decrease in voltage, such as a rectangular waveform or a ramp waveform, can prevent rapid dissolution of the conductive film, thereby suppressing surface roughening and excessive polishing of the conductive film (interconnect metal film). The frequency of the voltage is preferably set so as not to synchronize with the cycle of a through-hole of a polishing pad, passing a particular portion of the polishing object. This is because if the voltage frequency synchronizes with the above cycle, there will be processed/non-processed portions in the conductive film, resulting in a large variation in the thickness distribution of the conductive film.

A change in the thickness of the conductive film may be detected by a change in an eddy current. Further, the end point of polishing of the conductive film may be detected by a change in the eddy current.

A change in a thickness of a conductive film of a polishing object and the state of exposure of a barrier film can be monitored by sensing a change in an eddy current. Such monitoring can prevent excessive polishing of the conductive film, or can prevent excessive polishing of the conductive film (interconnect metal film), embedded, e.g., in trenches, after the beginning of exposure of the barrier film.

Alternatively, the end point of polishing of the conductive film may be detected by a change in the electrode potential of the conductive film.

A conductive film and a barrier film of a polishing object have different electrode potentials. Accordingly, the electrode potential changes when the conductive film is removed and the barrier film becomes exposed. By detecting the end point of polishing based on this change, excessive polishing of the conductive film (interconnect metal film) embedded, e.g., in trenches can be prevented.

Preferably, at least one of the flow rate distribution and the temperature distribution of the electrolytic liquid, filling the space between the first electrode and the conductive film of the polishing object, in the surface of the polishing object is controlled.

In electrochemical mechanical polishing which enables high polishing rate and good in-plane uniformity at a low polishing pressure, a voltage is applied to a surface of a conductive film of a polishing object, such as a wafer, to cause an electrochemical reaction. The in-plane distribution of an electrolytic liquid on the polishing object and the temperature distribution of the electrolytic liquid are parameters that affect the electrochemical reaction. A polishing pad for use in electrochemical mechanical polishing, unlike a polishing pad for use in common CMP, has through-holes extending between a conductive film of a polishing object and an electrode (processing electrode). Therefore, the in-plane uniformity of electrolytic liquid is very important. In particular, as shown in FIG. 12, there is such a relationship between the flow rate of electrolytic liquid and the polishing rate in electrochemical mechanical polishing that the polishing rate increases with an increase in the flow rate of electrolytic liquid. Further, as sown in FIG. 13, there is such a relationship between the temperature of electrolytic liquid and the polishing rate that the polishing rate increases with an increase in the temperature of electrolytic liquid, and the relationship is more market at a lower polishing pressure. Accordingly, the distribution of polishing amount in a surface to be polished of a conductive film of a polishing object can be controlled by controlling at least one of the flow rate distribution and the temperature distribution of the electrolytic liquid, filling the space between the first electrode and the conductive film of the polishing object, in the surface of the polishing object.

The flow rate distribution of the electrolytic liquid in the surface of the polishing object may be controlled by independently regulating the flow rates of the flows of the electrolytic liquid, which are supplied from a plurality of electrolytic liquid supply passages, based on a difference between the thickness distribution of the conductive film during polishing and an intended thickness distribution of the conductive film.

The temperature distribution of the electrolytic liquid in the surface of the polishing object may be controlled by independently regulating the temperatures of the flows of the electrolytic liquid, which are supplied from the plurality of electrolytic liquid supply passages, based on a difference between the thickness distribution of the conductive film during polishing and an intended thickness distribution of the conductive film.

The temperature of the electrolytic liquid is, for example, in the range of 10 to 50° C.

The relative movement speed between the polishing pad and the polishing object may be controlled.

The rotational speed of the polishing pad may be controlled, for example, in the range of 20 to 40 rpm, and the rotational speed of the polishing object may be controlled, for example, in the range of 50 to 100 rpm. The polishing object may be rotated in a direction opposite to the rotating direction of the polishing pad or pivoted in the rotating direction of the polishing pad, according to necessity.

The present invention provides an electrochemical mechanical polishing apparatus comprising: a polishing table holding a polishing pad and having a first electrode connected to one pole of a power source; a top ring for holding a polishing object having a conductive film, the top ring having a plurality of pressing areas for individually pressing the polishing object against a polishing surface of the polishing pad; at least one second electrode, connected to the other pole of the power source, for feeding electricity to the conductive film of the polishing object, the second electrode being disposed around at least one of the outer and inner circumferences of the first electrode in an electrically-insulated state from the first electrode; an electrolytic liquid supply section for supplying at least one type of electrolytic liquid to the polishing surface of the polishing pad; a movement mechanism for moving the polishing object and the polishing surface relative to each other; a detection section for detecting a signal corresponding to a thickness of the remaining conductive film; and a control section for controlling at least one of the applied voltage of the power source, the pressure of the top ring, the flow rate of the electrolytic liquid supplied from the electrolytic liquid supply section, and the speed of said relative movement, based on a signal from the detection section.

The distribution of polishing pressure in a surface of a polishing object can be changed, for example, from the uniform distribution to a concentric distribution (with at least 3 areas) so that the polishing pressure of an inner area of the polishing object is made higher than that of the remaining outer area (for example, the difference in polishing pressure between the inner area and an outermost area is made 0.01 to 0.5 psi). This makes it possible to make the polishing rate of a conductive film in the inner area of the polishing object higher than that of the conductive film in the outer area of the polishing object.

Preferably, the first electrode is comprised of a plurality of divided electrodes which can be independently controlled by the power source.

The distribution of voltage in a surface of a polishing object can be changed, for example, from the uniform distribution to a concentric distribution (with at least 3 areas) so that the voltage of an inner area of the polishing object is made higher than that of the remaining outer area (for example, the difference in voltage between the inner area and an outermost area is made 0.01 to 0.5 V). This makes it possible to make the polishing rate of a conductive film in the inner area of the polishing object higher than that of the conductive film in the outer area of the polishing object.

The second electrode may be composed of a resin material having electrical conductivity.

Preferably, the electric liquid supply section has a plurality of electrolytic liquid supply passages, and the flow rates of the flows of the electrolytic liquid supplied from the electrolytic liquid supply passages can be independently controlled by the control section.

In electrochemical mechanical polishing, the flow rate distribution of an electrolytic liquid affects the polishing rate. Thus, the distribution of polishing rate in a surface of a polishing object can be controlled by regulating the flow rate distribution of the electrolytic liquid.

Preferably, the electrolytic liquid supply section further has a temperature regulation section for independently regulating the temperatures of the flows of the electrolytic liquid flowing along the plurality of electrolytic liquid supply passages.

In electrochemical mechanical polishing, the temperature distribution of an electrolytic liquid affects the polishing rate. Thus, the distribution of polishing rate in a surface of a polishing object can be controlled by regulating the temperature distribution of the electrolytic liquid.

The detection section is, for example, an eddy current sensor.

A change in the thickness of a conductive film of a polishing object and the state of exposure of a barrier film can be monitored by sensing a change in an eddy current.

By feeding back the change to the polishing pressure distribution, the applied voltage distribution, the flow rate distribution of electrolytic liquid, and the relative speed between the polishing object and the polishing pad, the thickness of the remaining conductive film can be controlled and the conductive film (interconnect metal film), embedded, e.g., in trenches, can be prevented from being polished excessively after the beginning of exposure of the barrier film.

The detection section may be a reference electrode for detecting a change in the electrode potential of the conductive film.

The electrode potential of the conductive film or the barrier film can be measured by using a reference electrode. By detecting the end point of polishing based on a change in the electrode potential, excessive polishing of the conductive film (interconnect metal film) embedded, e.g., in trenches can be prevented.

Preferably, the control section controls polishing of the conductive film so that a barrier film underlying the conductive film becomes gradually exposed from the center toward the periphery of the polishing object.

This makes it possible to expose the barrier film underlying the conductive film without leaving the conductive film in an electrically-insulated state on the barrier film.

The present invention provides another electrochemical mechanical polishing method comprising: applying a voltage between a first electrode connected to one pole of a power source and a second electrode, connected to the other pole of the power source, for feeding electricity to a conductive film of a polishing object, filling an electrolytic liquid into a space between the first electrode and the conductive film of the polishing object; and pressing and rubbing the conductive film against a polishing surface of a polishing pad to polish the conductive film and expose a barrier film underlying the conductive film; wherein immediately before the exposure of the barrier film, an electrolytic liquid is used which forms a passive film, which makes the polishing rate of the conductive film not more than 50 nm/min, in the surface of the conductive film.

Preferably, when the electrolytic liquid is supplied, the voltage applied between the first electrode and the second electrode is adjusted in a voltage range which corresponds to a range of electrode potential in which the passive film is formed on the surface of the conductive film.

In order to achieve the above second object, the present invention provides yet another electrochemical mechanical polishing method comprising: bringing an electrolytic liquid having a pH of 4 to 10 into contact with a metal film composed of a conductive film, formed in a surface of a polishing object, and a barrier film underlying the conductive film; moving the polishing object and a polishing pad relative to each other while applying a first voltage to the metal film and pressing a surface of the polishing object against the polishing pad at a predetermined polishing pressure, thereby first removing the conductive film around a voltage application point from which said voltage is applied and exposing the barrier film underlying the conductive film; and applying a second voltage, which is higher than the first voltage, to the metal film immediately before or after the exposure of the barrier film, thereby removing the conductive film, the second voltage being such as to make the voltage in a region where the barrier film is exposed higher than a threshold voltage, the threshold voltage being a voltage at which the current density turns from increase into decrease when said voltage is increased while moving the polishing object and the polishing pad relative to each other at a polishing pressure of 0.

As the voltage applied to a conductive film is increased while keeping the conductive film in contact with an electrolytic liquid having a pH of 4 to 10, the current density rapidly changes at a certain voltage. As the voltage applied to the conductive film is increased from 0, the current density increases in proportion to the voltage until the voltage reaches a first change voltage at a first change point (e.g., point A shown in FIG. 27), but the increase in the current density with the applied voltage turns into decrease at the first change voltage. The degree of decrease in the current density drops and the current density comes to take an approximately constant value when the voltage is increased after exceeding a second change voltage at a second change point (e.g., point B shown in FIG. 27). It is considered in this regard that a protective film, which is soluble in the electrolytic liquid, will be formed on the surface of the conductive film when a voltage, which is not more than the first change voltage, is applied to the conductive film, whereas a protective film, which is insoluble in the electrolytic liquid, will be formed on the surface of the conductive film when a voltage, which is not less than the second change voltage, is applied to the conductive film.

It was the discovery by the present inventors that the polishing rate can be controlled at any surface portion of a substrate (polishing object) by regulating the electric potential at that portion. There is a difference in electric resistance between the metal films formed in the surface of a substrate, i.e., a lower barrier film and an upper conductive film. The electric potential at a particular portion of the substrate can be regulated by utilizing the difference. A voltage is applied to the substrate surface from a voltage application point provided on the surface of a metal film, and an approximately uniform voltage is applied to the entire surface of the substrate when the conductive film remains over the entire substrate surface. However, the voltage distribution in the substrate surface changes when the conductive film around the voltage application point is removed and part of the barrier film becomes exposed. In particular, the voltage comes to be applied to the conductive film via the barrier film having a higher electric resistance than the conductive film, whereby the voltage applied to the conductive film becomes low depending on the distance from the voltage application point.

According to the present invention, the current density turns into decrease when the voltage in a barrier film-exposed region exceeds the threshold voltage, whereby the polishing rate of the conductive film becomes low. Accordingly, even when the conductive film, which is to become contact plugs or interconnects, is present in the barrier film-exposed region, dishing is less likely to occur in the surface of such conductive film. Further, polishing is carried out by utilizing an electrochemical dissolution action. There is, therefore, no need for the use of the conventional slurry having a high concentration of abrasive grains and, in addition, no need for high-pressure polishing. Thus, the proportion of mechanical polishing action can be lowered, thereby preventing the occurrence of erosion.

On the other hand, in a region where the conductive film having a lower electric resistance than the barrier film remains, the voltage applied to the conductive film becomes low depending on the distance from a barrier film-exposed region. Thus, such a conductive film-remaining region is kept at a relatively high current density as compared to the barrier film-exposed region. Accordingly, polishing continues to progress in the conductive film-remaining region. It thus becomes possible to quickly remove the conductive film while suppressing dishing as well as damage such as scratches.

The second voltage may be a voltage which makes the voltage in the other region than said barrier film-exposed region higher than said threshold voltage and not more than a maximum voltage, the maximum voltage being a voltage at which the current density turns from decrease after increase into constancy as said voltage is increased when said polishing pressure is a finite value.

By thus setting the voltage in the other region than a barrier film-exposed region, i.e., the region in which the conductive film remains, at a voltage which is higher than the threshold voltage and not more than the maximum voltage, the current density can be maintained at a high level in the conductive film-remaining region until the conductive film is removed and flattened to the same level as the barrier film even when the conductive film, which is to become contact plugs or interconnects, is present in the conductive film-remaining region. The progress of polishing and flattening thus becomes possible for a conductive film-remaining region.

Preferably, in the step of exposing the barrier film, the polishing pressure between the polishing object and the polishing pad in a region around the voltage application point is made higher than the polishing pressure in the other region than the region around the voltage application point.

By thus making the polishing pressure in a region around the voltage application point higher than the polishing pressure in the other region than the region around the voltage application point, polishing is promoted in the region around the voltage application point as compared to the other region, whereby the conductive film in the former region is first removed. Therefore, a voltage distribution can be obtained in which the voltage applied to the metal film becomes highest in the region around the voltage application point, and the voltage decreases with distance from the region. Accordingly, in the step of applying the second voltage after the exposure of the barrier film, the remaining conductive film can be removed with precision.

A counter electrode may be used which faces the polishing object and is comprised of a plurality of small divided electrodes arranged concentrically on the same plane, and in the step of exposing the barrier film, the voltages of the divided electrodes are controlled so that the polishing rate increases with the frequency of each divided electrode facing the periphery of the polishing object.

By thus controlling the voltages of the divided electrodes so that the polishing rate increases with the frequency of each divided electrode facing the periphery of a substrate (polishing object), it becomes possible to progress polishing in such a manner that the thickness of the remaining conductive film decreases with distance from the center of the substrate, thereby securely exposing the barrier film in the periphery of the substrate.

Preferably, polishing of the conductive film is carried out while measuring the thickness of the remaining conductive film by an eddy current method.

The use of an eddy current method enables high-precision measurement of the thickness of the remaining conductive film.

The conductive film is, for example, a tungsten film.

The use of a tungsten film as the conductive film facilitates the above-described regulation of polishing rate.

The present invention provides yet another electrochemical mechanical polishing method comprising; bringing an electrolytic liquid having a pH of 4 to 10 into contact with a metal film composed of a conductive film, formed in a surface of a polishing object, and a barrier film underlying the conductive film; moving the polishing object and a polishing pad relative to each other while applying a voltage to the metal film from a voltage application point disposed on a peripheral portion of the polishing object and pressing a surface of the polishing object against the polishing pad at a predetermined polishing pressure, thereby first removing the conductive film around the voltage application point and exposing the barrier film underlying the conductive film; and then moving the voltage application point from the peripheral portion to the center of the polishing object, thereby further exposing the barrier film.

By thus moving the voltage application point from the periphery to the center of a substrate (polishing object) after exposing the barrier film, a high voltage can be maintained in the region where the barrier film is exposed. Accordingly, even when the conductive film, which is to become contact plugs or interconnects, is present in the barrier film-exposed region, dishing is less likely to occur in the surface of such conductive film.

The present invention provides yet another electrochemical mechanical polishing method comprising: bringing an electrolytic liquid having a pH of 4 to 10 into contact with a metal film composed of a conductive film, formed in a surface of a polishing object, and a barrier film underlying the conductive film; moving the polishing object and a polishing pad relative to each other while applying a voltage to the metal film from a voltage application point disposed on a peripheral portion of the polishing object and pressing a surface of the polishing object against the polishing pad at a predetermined polishing pressure, thereby first removing the conductive film around the voltage application point and exposing the barrier film underlying the conductive film; moving the voltage application point from the peripheral portion to the center of the polishing object, thereby further exposing the barrier film; and applying a second voltage, which is higher than the first voltage, to the metal film immediately before or after the exposure of the barrier film, thereby removing the conductive film, the second voltage being such as to make the voltage in a region where the barrier film is exposed higher than a threshold voltage, the threshold voltage being a voltage at which the current density turns from increase into decrease when said voltage is increased while moving the polishing object and the polishing pad relative to each other at a polishing pressure of 0.

By thus moving the voltage application point from the periphery to the center of a substrate (polishing object), the voltage in the region where the barrier film is exposed can be made not less than the threshold voltage without the need for a considerable rise of the applied voltage. Accordingly, even when the conductive film, which is to become contact plugs or interconnects, is present in the barrier film-exposed region, dishing is less likely to occur in the surface of such conductive film.

### BRIEF DESCRIPTION OF THE DRAWINGS

FIGS. 1A through 1C are diagrams illustrating, in a sequence of process steps, a process for forming copper interconnects in a semiconductor device;

FIG. 2 is a graph showing the relationship between polishing rate and polishing pressure in common CMP;

FIG. 3 is a cross-sectional diagram illustrating a substrate before polishing, having a tungsten conductive film which is to form interconnects;

FIG. 4 is a vertical sectional view schematically showing the main portion of a chemical mechanical polishing apparatus;

FIG. 5 is a layout plan view of a substrate processing apparatus provided with an electrochemical mechanical polishing apparatus according to the present invention;

FIG. 6 is a vertical sectional front view showing the main portion of an electrochemical mechanical polishing apparatus according to an embodiment of the present invention, provided in the substrate processing apparatus shown in FIG. 5;

FIG. 7 is a vertical sectional view of a top ring of the electrochemical mechanical polishing apparatus;

FIG. 8 is a bottom view of the top ring of the electrochemical mechanical polishing apparatus;

FIG. 9 is a plan view showing, together with a substrate, a second electrode and a polishing pad of a polishing table of the electrochemical mechanical polishing apparatus;

FIG. 10 is a vertical sectional front view of FIG. 9;

FIG. 11 is a plan view showing, together with a substrate and a dresser, an electrolytic liquid supply nozzle of the polishing table of the electrochemical mechanical polishing apparatus;

FIG. 12 is a graph showing the relationship between polishing rate and the flow rate of electrolytic liquid in electrochemical mechanical polishing;

FIG. 13 is a graph showing the relationship between polishing rate and the temperature of electrolytic liquid in electrochemical mechanical polishing;

FIG. 14 is a diagram illustrating the state of exposure of a barrier film during the period from the beginning to the completion of exposure of the barrier film;

FIG. 15 is a copper potential-pH diagram;

FIG. 16 is a cross-sectional diagram illustrating the formation of a passive film (passive oxide film) on a surface of a conductive film (interconnects);

FIG. 17 is a graph showing the relationship between current value and electrode potential during electrochemical mechanical polishing;

FIGS. 18A through 18C are diagrams showing various waveforms of voltages that can be applied during the period from the beginning to the completion of exposure of a barrier film;

FIG. 19 is a plan view showing, together with a substrate, a first electrode, a second electrode and a polishing pad of another polishing table of the electrochemical mechanical polishing apparatus;

FIG. 20 is a vertical sectional front view of FIG. 19;

FIG. 21 is a plan view showing, together with a substrate, a first electrode, a second electrode and a polishing pad of yet another polishing table of the electrochemical mechanical polishing apparatus;

FIG. 22 is a vertical sectional front view of FIG. 21;

FIG. 23 is a front view schematically showing yet another polishing table of the electrochemical mechanical polishing apparatus;

FIG. 24 is a front view schematically showing an electrochemical mechanical polishing apparatus according to another embodiment of the present invention;

FIGS. 25A and 25B are vertical sectional views schematically showing the main portions of different electrochemical mechanical polishing apparatuses for use in polishing of a conductive film of tungsten;

FIGS. 26A through 26C are cross-sectional diagrams illustrating, in a sequence of process steps, polishing of a conductive film by electrochemical mechanical polishing;

FIG. 27 is a graph showing the relationship between the electric potential of conductive film and the current density;

FIGS. 28A through 28C are schematic diagrams illustrating the formation of a protective film as observed when voltages, which are in the respective regions shown in FIG. 27, are applied; and

FIG. 29 is a plan view showing the construction of yet another polishing table.

### DETAILED DESCRIPTION OF THE PREFERRED EMBODIMENTS

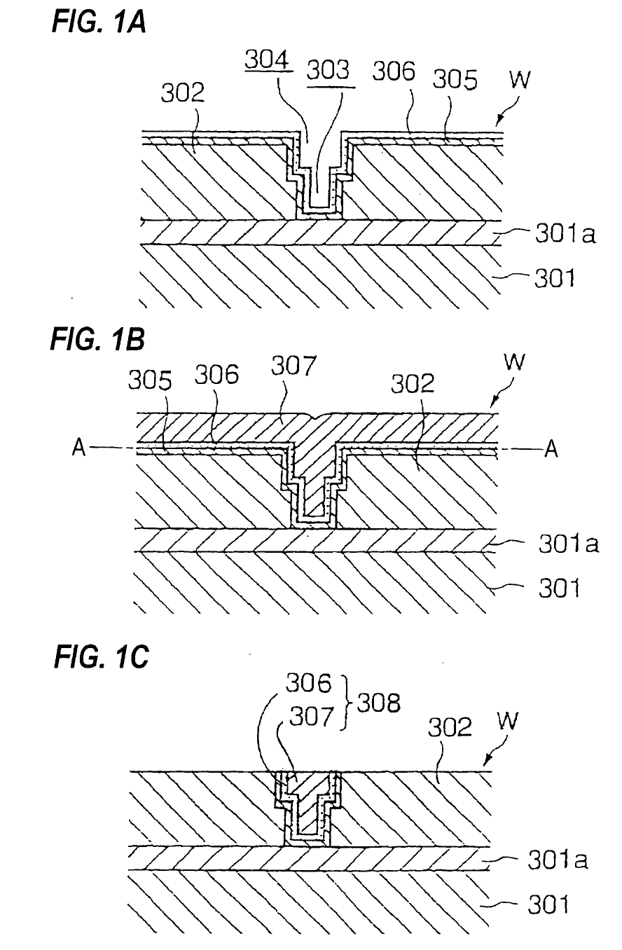

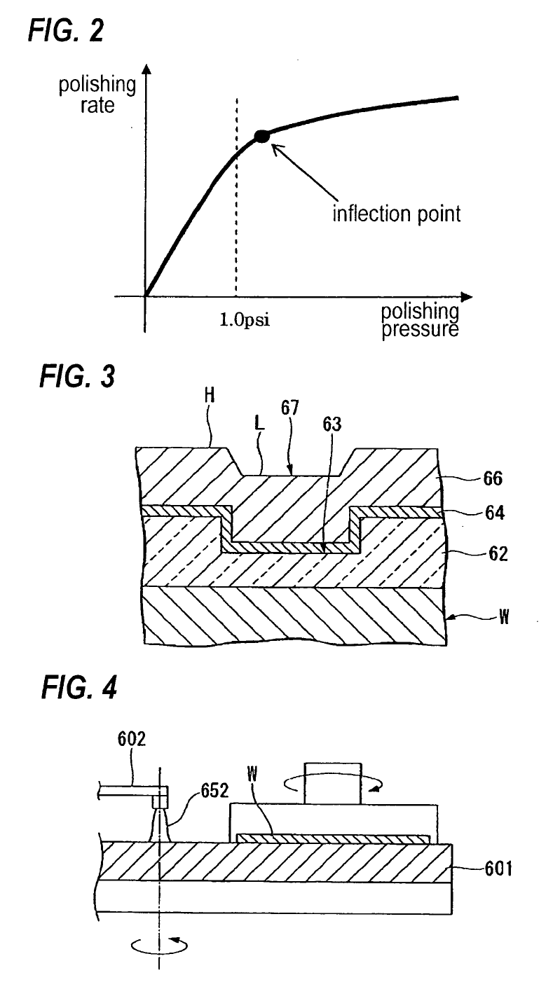

Preferred embodiments of the present invention will now be described with reference to the drawings. The following description illustrates a polishing process (first electrochemical mechanical polishing) for removing a conductive film, comprised of a copper film 307 (and a seed film 306) which is to form interconnects, formed on a barrier film 305 of a substrate W as a polishing object as shown in FIG. 1B, thereby exposing the barrier film 305, and also illustrates a polishing process (second electrochemical mechanical polishing) for removing a conductive film 66 of tungsten, which is to form interconnects, formed on a barrier film 64 of a substrate W as a polishing object as shown in FIG. 3, thereby exposing the barrier film 64. In the following description, the same or equivalent members are given the same reference numerals, and a duplicate description thereof will be omitted.

### (First Electrochemical Mechanical Polishing)

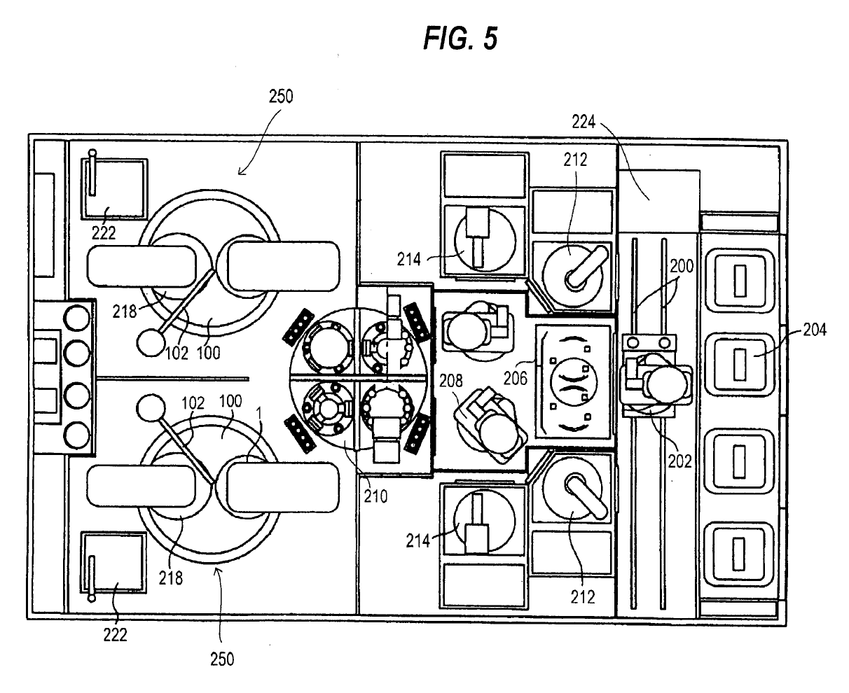

FIG. 5 is a layout plan view of a substrate processing apparatus provided with an electrochemical mechanical polishing apparatus according to the present invention. The substrate processing apparatus can be used to carry out polishing of, e.g., a substrate (polishing object) W as shown in FIG. 1B, which has been subjected to copper plating to fill copper into via holes 303 and trenches 304 and deposit a copper film 307 as an interconnect metal film on an insulating film 302. The polishing is carried to the level shown by the line A-A in FIG. 1B, thus removing the copper film 307 (and a seed film 306) as a conductive film on the insulating film 302 and exposing the barrier film 305. By further removing the barrier film 305 on the insulating film 302, interconnects 308 composed of the seed film 306 and the copper film 307 are formed in the insulating film 302 as shown in FIG. 1C.

This substrate processing apparatus comprises a loading and unloading stage for accommodating substrate cassettes 204 adapted to store therein substrates W (see FIG. 1B) each having the copper film 307 as the interconnect metal film (i.e., conductive film). A transport robot 202, having two hands, is provided on a moving mechanism 200 so that the hands can reach the substrate cassettes 204 in the loading and unloading stage. The moving mechanism 200 has mechanisms including a linear motor. Use of the linear motor allows the moving mechanism 200 to quickly and stably transfer a substrate having an increased diameter and an increased weight.

Two drying units 212 are provided at an opposite side of the substrate cassettes 204 with respect to the moving mechanism 200 for the transport robot 202. These drying units 212 are arranged within reach of the hands of the transport robot 202. A substrate station 206, having four substrate stages, is provided between the drying units 212. This substrate station 206 is arranged within reach of the bands of the transport robot 202.

Transport robots 208 are provided in positions where hands thereof can reach the drying units 212 and the substrate station 206. Cleaning units 214 are provided next to the drying units 212, respectively. The cleaning units 214 are arranged within reach of the hands of the transport robots 208. A rotary transporter 210 is arranged within reach of the hands of the transport robots 208. Two electrochemical mechanical polishing apparatuses 250 according to an embodiment of the present invention are provided in positions where the substrates W can be transferred to and from the rotary transporter 210. In this embodiment, one of the two electrochemical mechanical polishing apparatuses 250 is used to perform first polishing of the copper film 307 (and the seed film 306), and another is used to perform second polishing.

The substrate processing apparatus further comprises an ITM (In-line Thickness Monitor) 224, which is a measuring section for measuring a state of a surface, e.g., a thickness of a film on the surface, of the substrate that is to be polished or that has been cleaned and dried after being polished. More specifically, as shown in FIG. 5, the ITM (measuring section) 224 lies on an extension of the moving mechanism 200, and is operable to measure a polishing state of the copper film, the barrier film, and the like on the surface of the substrate, such as semiconductor wafer, before the transport robot 202 returns a polished substrate to the substrate cassette 204 or after the transport robot 202 removes a substrate, to be polished, from the substrate cassette 204 (In-line). The ITM 224 has an optical device for emitting an optical signal to the surface of the substrate, and measures the polishing state of the surface of the substrate from the reflected optical signal from the substrate.

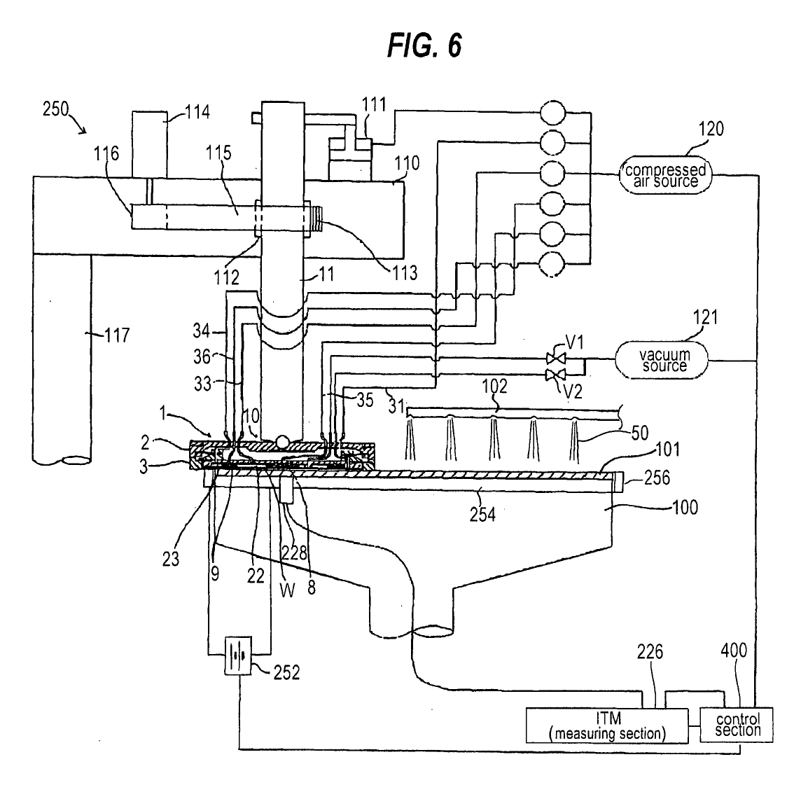

Each of the electrochemical mechanical polishing apparatuses 250 has a polishing table 100, a top ring 1, an electrolytic liquid supply nozzle 102 for supplying an electrolytic liquid to a polishing pad 101 (see FIGS. 6 and 10) on the polishing table 100, a dresser 218 for dressing the polishing pad 101 on the polishing table 100, and a water vessel 222 for cleaning the dresser 218.

FIG. 6 shows an essential part of the electrochemical mechanical polishing apparatus 250. As shown in FIG. 6, the top ring 1 is coupled to a top ring drive shaft 11 via a universal joint 10, and the top ring drive shaft 11 is coupled to a top ring air cylinder 111 secured to a top ring head 110. The top ring drive shaft 1 is moved vertically by the top ring air cylinder 111 to thereby move up and down the top ring 1 in its entirety and to press a retainer ring 3, which is fixed to a lower end of a top ring body 2, against the polishing pad 101. The top ring air cylinder 111 is coupled to a compressed air source 120 via a regulator RE1. The regulator RE1 can regulate pressure of a fluid, e.g., an air, to be supplied to the top ring air cylinder 111, whereby pressure applied to the retainer ring 3 to press the polishing pad 101 can be adjusted.

The top ring drive shaft 11 is coupled to a rotational cylinder 112 via a key (not shown). The rotational cylinder 112 is provided with a timing pulley 113 on its peripheral portion A top ring motor 114, serving as a rotating device, is secured to the top ring head 110, and a timing pulley 116 is coupled to the top ring motor 114. The timing pulley 113 is coupled to the timing pulley 116 via a timing belt 11S. With these arrangements, by energizing the top ring motor 114, the rotational cylinder 112 and the top ring drive shaft 11 are integrally rotated via the timing pulley 116, the timing belt 115, and the timing pulley 113, whereby the top ring 1 is rotated. The top ring head 110 is supported by an arm shaft 117 secured to a frame (not shown).

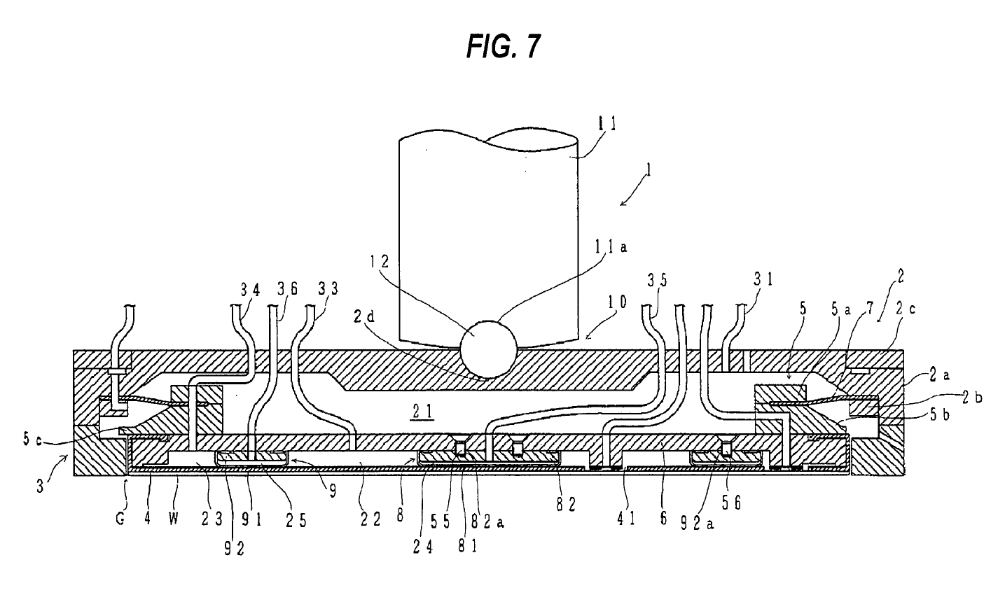

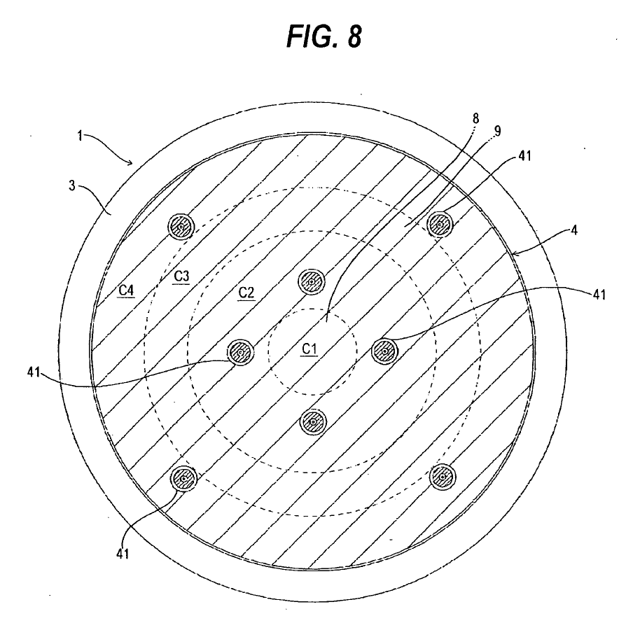

The top ring 1 will now be described in more detail with reference to FIGS. 7 and 8. FIG. 7 is a vertical cross-sectional view of the top ring 1, and FIG. 8 is a bottom view of the top ring 1 shown in FIG. 7. As shown in FIG. 7, the top ring 1 has the top ring body 2 in a shape of a cylindrical vessel having a space therein, and the retainer ring 3 fixed to a lower end of the top ring body 2. The top ring body 2 is formed of a material having a high strength and a high rigidity, such as metal or ceramic. The retainer ring 3 is formed of a resin having a high rigidity or ceramic.

The top ring body 2 includes a housing 2a in a shape of a cylindrical vessel an annular pressure-sheet support 2b fitted into a cylindrical inner portion of the housing 2a, and an annular sealing member 2c attached to a periphery of an upper surface of the housing 2a. A lower portion of the retainer ring 3, fixed to a lower surface of the housing 2a of the top ring body 2, projects inwardly. The retainer ring 3 may be formed integrally with the top ring body 2.

The above-described top ring drive shaft 11 is located above a center of the housing 2a of the top ring body 2. The top ring body 2 and the top ring drive shaft 11 are coupled to each other by the universal joint 10. The universal joint 10 includes a spherical bearing mechanism and a rotation transmitting mechanism. The spherical bearing mechanism allows the top ring body 2 and the top ring drive shaft 11 to tilt with respect to each other, and the rotation transmitting mechanism transmits rotation of the top ring drive shaft 11 to the top ring body 2. With these mechanisms, the universal joint 10 transmits a pressing force and a torque of the top ring drive shaft 11 to the top ring body 2, while permitting tilting of the top ring body 2 with respect to the top ring drive shaft 11.

The spherical bearing mechanism has a spherical recess 11a formed in a central portion of a lower surface of the top ring drive shaft 11, a spherical recess 2d formed in the central portion of the upper surface of the housing 2a, and a bearing ball 12 made from a high-hardness material, such as ceramic, interposed between the recesses 11a and 2d. The rotation transmitting mechanism has driving pins (not shown) fixed to the top ring drive shaft 11, and driven pins (not shown) fixed to the housing 2a. The driving pins and the driven pins are vertically movable relative to each other. Accordingly, even when the top ring body 2 is tilted, the pins still engage each other, with contact points of the pins being shifted. The rotation transmitting mechanism thus securely transmits the torque of the top ring drive shaft 11 to the top ring body 2.

In the space formed in the top ring body 2 and the retainer ring 3 fixed integrally to the top ring body 2, there are housed an elastic pad 4 to be in contact with the substrate W, such as semiconductor wafer, held by top ring 1, an annular holder ring 5, and a substantially disk-shaped chucking plate 6 for supporting the elastic pad 4. The elastic pad 4 is sandwiched, at its peripheral portion, between the holder ring 5 and the chucking plate 6 fixed to a lower end of the holder ring 5. The elastic pad 4 is shaped so as to cover a lower surface of the chucking plate 6. A space is thus formed between the elastic pad 4 and the chucking plate 6.

A pressure sheet 7, composed of an elastic membrane, is provided so as to stretch between the holder ring 5 and the top ring body 2. One end of the pressure sheet 7 is sandwiched between the housing 2a and the pressure-sheet support 2b of the top ring body 2, and another is sandwiched between an upper end portion 5a and a stopper portion 5b of the holder ring 5. A pressure chamber 21 is formed inside the top ring body 2. This pressure chamber 21 is defined by the top ring body 2, the chucking plate 6, the holder ring 5, and the pressure sheet 7. As shown in FIG. 7, a fluid passage 31, which comprises a tube and connectors, is provided so as to communicate with the pressure chamber 21. The pressure chamber 21 is coupled to the compressed air source 120 via a regulator RE2 provided in the fluid passage 31. The pressure sheet 7 is made from, for example, a rubber material having excellent strength and durability, such as ethylene-propylene rubber (EPDM), polyurethane rubber, or silicon rubber.

If the pressure sheet 7 is made from an elastic material, such as rubber, and is sandwiched between the retainer ring 3 and the top ring body 2, a desirable flat plane may not be obtained in the lower surface of the retainer ring 3, because of elastic deformation of the elastic pressure sheet 7. In order to avoid such a drawback, the pressure-sheet support 2b is separately provided, according to this embodiment, so as to sandwich and fix the pressure sheet 7 between the housing 2a and the pressure-sheet support 2b of the top ring body 2.

It is possible to make the retainer ring 3 vertically movable relative to the top ring body 2 or to make the retainer ring 3 operable to press the polishing pad 101 independent of the top ring body 2, as disclosed in Japanese Patent Application No. H8-50956 (Laid-Open Publication No. H9-168964) or Japanese Patent Application No. H11-294503. In such a case, the above-described structure of fixing the pressure sheet 7 may not necessarily be employed.

A center bag (a central contact member) 8 and a ring tube (an outer contact member) 9, which are contact members to be in contact with the elastic pad 4, are provided in the space formed between the elastic pad 4 and the chucking plate 6. As shown in FIGS. 7 and 8, in this embodiment, the center bag 8 is disposed on the central portion of the lower surface of the chucking plate 6, and the ring tube 9 is disposed outside of the center bag 8 so as to surround the center bag 8. The elastic pad 4, the center bag 8, and the ring tube 9 are made from rubber having excellent strength and durability, such as ethylene-propylene rubber (EPDM), polyurethane rubber, or silicon rubber, as with the pressure sheet 7.

The space formed between the chucking plate 6 and the elastic pad 4 is divided by the center bag 8 and the ring tube 9 into plural chambers: a pressure chamber 22 formed between the center bag 8 and the ring tube 9; and a pressure chamber 23 formed outside the ring tube 9.

The center bag 8 comprises an elastic membrane 81, which is to be in contact with an upper surface of the elastic pad 4, and a center bag holder (holding member) 82 detachably holding the elastic membrane 81. The center bag holder 82 has screw holes 82a formed therein. Screws 55 are inserted into the screw holes 82a to thereby allow the center bag 8 to be detachably mounted on the central portion of the lower surface of the chucking plate 6. Inside the center bag 8, a central pressure chamber 24 is defined by the elastic membrane 81 and the center bag holder 82.

Similarly, the ring tube 9 comprises an elastic membrane 91, which is to be in contact with the upper surface of the elastic pad 4, and a ring tube holder (holding member) 92 detachably holding the elastic membrane 91. The ring tube holder 92 has screw holes 92a formed therein. Screws 56 are inserted into the screw holes 92a to thereby allow the ring tube 9 to be detachably mounted on the lower surface of the chucking plate 6. Inside the ring tube 9, an intermediate pressure chamber 25 is defined by the elastic membrane 91 and the ring tube holder 92.

Fluid passages 33, 34, 35, and 36, each including a tube and connectors, are provided so as to communicate with the pressure chambers 22, 23, the central pressure chamber 24, and the intermediate pressure chamber 25, respectively. The pressure chambers 22 to 25 are coupled to the compressed air source 120 as a pressurized-fluid supply source via regulators RE3, RE4, RE5, and RE6 respectively provided in the fluid passages 33 to 36. The above-described fluid passages 31, 33 to 36 are coupled to the respective regulators RE2 to RE6 via rotary joints (not shown) provided at an upper end of the top ring drive shaft 11.

A pressurized fluid, such as pressurized air, atmospheric pressure or vacuum is to be supplied to the above-described pressure chamber 21, located above the chucking plate 6, and the pressure chambers 22 to 25 via the fluid passages 31, 33 to 36 communicated with each of pressure chambers. As shown in FIG. 6, the pressures of pressurized fluids to be supplied to the pressure chambers 21 to 25 can be adjusted by the regulators RE2 to RE6 provided in the fluid passages 31, 33 to 36. The pressures in the pressure chambers 21 to 25 can thus be controlled independently, or atmospheric pressure or vacuum can be produced in the pressure chambers 21 to 25.

In this manner, by changing the pressures in the pressure chambers 21 to 25 independently via the regulators RE2 to RE6, the elastic pad 4 can press the substrate W against the polishing pad 101 with pressing forces adjusted for respective portions (divisional areas) of the substrate W. The pressure chambers 21 to 25 may be coupled to a vacuum source 121, as desired.

As shown in FIG. 6, the polishing table 100 of the electrochemical mechanical polishing apparatus 250 is made of e.g., SUS or titanium, or metal covered with platinum on its surface. A coil sensor 228 of the ITM 226, such as an eddy current sensor, with which a film thickness of, e.g., a copper film of a substrate surface is measured, is embedded in the polishing table 100. Signals from the ITM 224 are inputted into a control section 400, and the regulators 2 to RE6 are controlled by signals outputted from the control section 400.

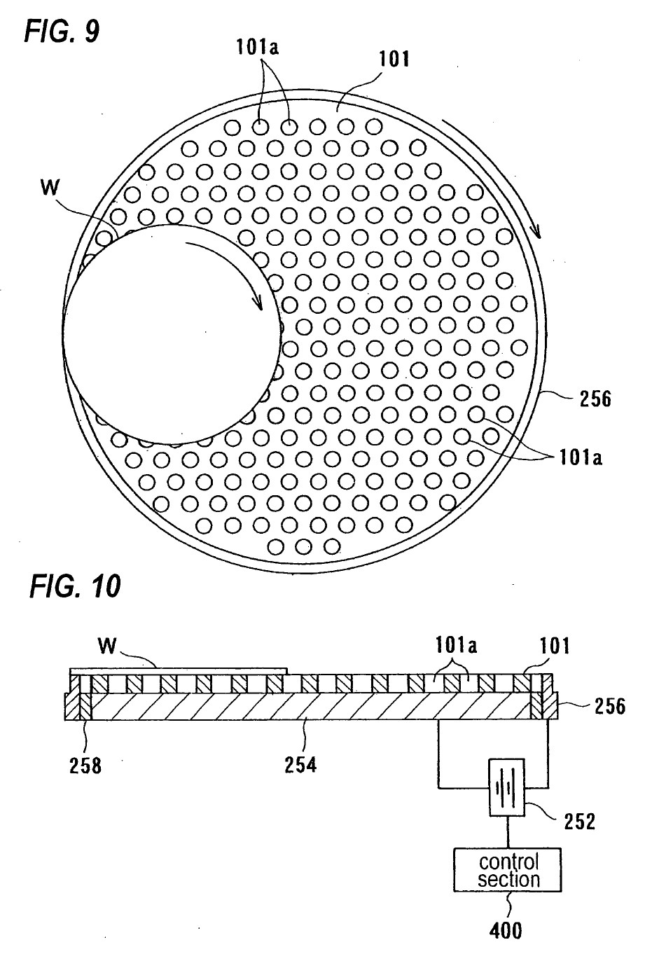

As shown in FIGS. 9 and 10, on the upper surface of the polishing table 100 are disposed a disk-shaped first electrode (cathode) 254 connected to one pole of a power source 252 and a ring-shaped second electrode (anode) 256 connected to the other pole of the power source 252, the electrodes being electrically insulated from each other by an insulator 258. The entire surface of the first electrode 254 is covered with a polishing pad 101 whose upper surface serves as a polishing surface. The polishing surface is approximately flush with the upper surface of the second electrode 256. The power source 252 is controlled by the control section 400.

Though in this embodiment the second electrode 256 is disposed such that it extends continuously in a ring along the circumference of the first electrode 254, it is also possible to divide the second electrode 256 and connect each of the divided electrodes to the power source 252. This can reduce a voltage difference in the ring-shaped second electrode. It is also possible to connect the power source 252 via a plurality of conducting wires to the one ring-shaped continuous second electrode 256. This can also reduce a voltage difference in the ring-shaped second electrode. It is also possible to use a pad-like conductive member as the second electrode 256.

When a substrate W held by the top ring 1 is lowered and the surface (lower surface) of the substrate W is brought into contact with the polishing surface of the polishing pad 101, the upper surface of the second electrode 256 comes into contact with a peripheral portion of the surface of the substrate W so that electricity can be fed to a conductive film, such as the copper film 307 (see FIG. 1B), formed in the surface of the substrate W. The top ring 1 is designed to press a substrate, held by the top ring 1, against the polishing surface of the polishing pad 101, e.g., at a polishing pressure of not more than 70 hPa (about 1 psi).

As shown in FIGS. 9 and 10, in this embodiment, the polishing pad 101 is composed of IC-1000, manufactured by Nitta Haas Inc., having a large number of through-holes 101a all over the body. During electrolytic polishing, electric current flows between a surface of a substrate W, connected to the second electrode 256, and the first electrode 254 via an electrolytic liquid that has flowed into the through-holes 101a. The polishing pad 101 may have grid-like or annular grooves, provided the pad has through-holes all over the body. If the polishing pad 101 itself is permeable to liquid, like a PVA resin pad having continuous pores, it may not necessarily have through-holes.

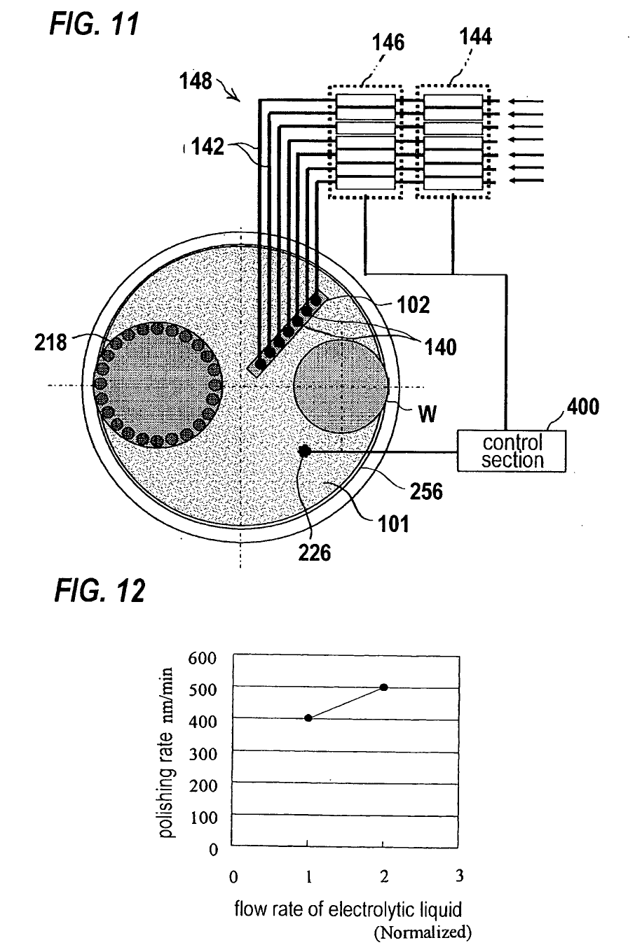

As shown in FIGS. 6 and 11, the electrolytic liquid supply nozzle 102 extends in the radial direction of the polishing pad 101 and has a plurality of electrolytic liquid supply orifices 140 arranged at regular intervals along the length direction. To each electrolytic liquid supply orifice 140 is connected an electrolytic liquid supply line (electrolytic liquid supply passage) 142 extending from an electrolytic liquid tank. In the electrolytic liquid supply lines 142 are interposed a flow rate regulation section 144, e.g., having flow rate regulation valves for individually regulating the flow rates of an electrolytic liquid flowing along the electrolytic liquid supply lines 142, and a temperature regulation section 146, e.g., having heat exchangers for individually regulating the temperatures of the electrolytic liquid flowing along the electrolytic liquid supply lines 142. The nozzle 102, the lines 142, and the regulation sections 144 and 146 constitute an electrolytic liquid supply section 148. The flow rate regulation valves of the flow rate regulation section 144 and the heat exchangers of the temperature regulation section 146 are controlled, e.g., by an output signal which is outputted from the control section 400 based on a signal inputted into the control section 400 from the ITM 226, such as the eddy current sensor disposed under the polishing pad 101 of the polishing table 100, shown in FIG. 6.

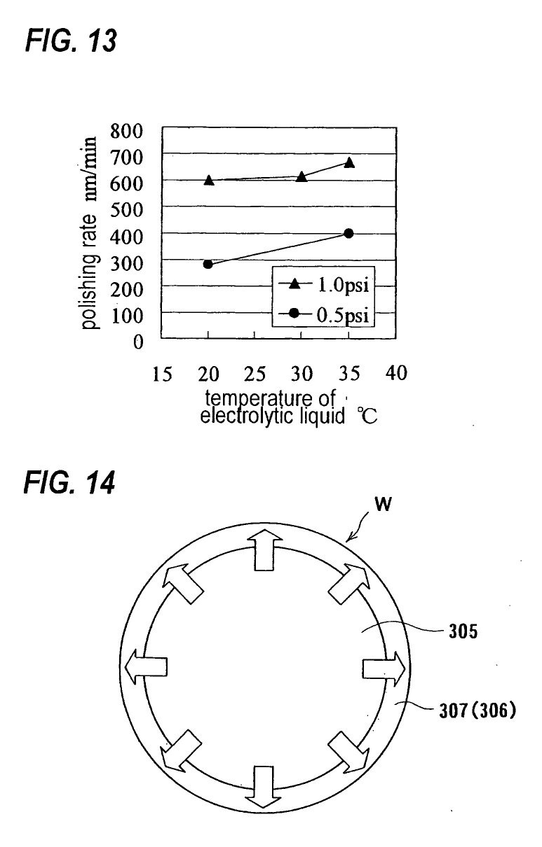

As shown in FIG. 12, there is such a relationship between the flow rate of electrolytic liquid and the polishing rate in electrochemical mechanical polishing that the polishing rate increases with an increase in the flow rate of electrolytic liquid. Further, as shown in FIG. 13, there is such a relationship between the temperature of electrolytic liquid and the polishing rate that the polishing rate increases with an increase in the temperature of electrolytic liquid, and the relationship is more market at a lower polishing pressure. It is therefore preferred to supply an electrolytic liquid to the polishing pad 101 using the plurality of electrolytic liquid supply lines (electrolytic liquid supply passages) 142, which are independently controllable for the flow rate and the temperature of the electrolytic liquid, and the electrolytic liquid supply nozzle 102 having the plurality of electrolytic liquid supply orifices 140. This enables control of the distribution of polishing rate in the conductive film.

Polishing operations of the electrochemical mechanical polishing apparatus 250 having the above structures will now be described. The substrate W is held on the lower surface of the top ring 1, and the cylinder 111, coupled to the top ring drive shaft 11, is actuated to press the retainer ring 3, fixed to the lower end of the top ring 1, against the polishing surface of the polishing pad 101 at predetermined pressure. Pressurized fluids with predetermined pressures are supplied respectively to the pressure chambers 22, 23, the central pressure chamber 24, and the intermediate pressure chamber 25 to thereby press the substrate W against the polishing surface of the polishing pad 101. At this time, the periphery of the substrate W comes into contact with the upper surface of the second electrode 256 to enable supply of the electric current to the conductive film, such as the copper film 307 (see FIG. 1B), formed on the surface of the substrate W.

Then, a voltage is applied between the first electrode 254 and the conductive film, such as the copper film 307, formed on the surface of the substrate W by the power source 252. Simultaneously, the electrolytic liquid 50 is supplied through the electrolytic liquid supply nozzle 102 to the polishing surface, whereby the electrolytic liquid 50 is held in and on the polishing pad 101. Therefore, polishing of the conductive film is carried out in the presence of the electrolytic liquid 50 between the surface of the conductive film of the substrate W and the polishing surface of the polishing pad 101.

In the polishing of the conductive film, the flow rate distribution and the temperature distribution of the electrolytic liquid in the surface of the conductive film being polished affect the polishing rate of the conductive film. It is therefore preferred to supply the electrolytic liquid to the polishing pad 101 using the electrolytic liquid supply nozzle 102 having the plurality of electrolytic liquid supply orifices 140 which are independently controllable for the flow rate and the temperature of the electrolytic liquid, as shown in FIG. 11. This enables control of the distribution of polishing rate in the conductive film.

The portions of the substrate W, which lie underneath the pressure chambers 22, 23, are pressed against the polishing surface by the pressures of the pressurized fluid supplied to the pressure chambers 22, 23. The portion of the substrate W, which lies underneath the central pressure chamber 24, is pressed against the polishing surface, via the elastic membrane 81 of the center bag 8 and the elastic pad 4, by the pressure of the pressurized fluid supplied to the central pressure chamber 24. The portion of the substrate W, which lies underneath the intermediate pressure chamber 25, is pressed against the polishing surface, via the elastic membrane 91 of the ring tube 9 and the elastic pad 4, by the pressure of the pressurized fluid supplied to the intermediate pressure chamber 25.

Accordingly, the polishing pressure applied to the substrate W can be adjusted individually for the divisional portions, divided along a radial direction of the substrate W, by controlling the pressures of pressurized fluid to be supplied to the pressure chambers 22 to 25. In particular, the control section 400 controls the pressures of pressurized fluid, to be supplied to the pressure chambers 22 to 25, independently via the regulators RE3 to RE6, thereby adjusting the pressures applied to press the substrate W against the polishing pad 101 on the polishing table 100 independently for the divisional portions of the substrate W. The substrate W can thus be pressed against the polishing pad 101 with the polishing pressure being adjusted to a desired value for each divisional portion of the substrate W. Similarly, the pressure of the pressurized fluid to be supplied to the top ring air cylinder 111 can be adjusted via the regulator RE1 so as to change the pressure applied to the retainer ring 3 pressing the polishing pad 101.

By thus appropriately adjusting, during polishing, the pressure applied to the retainer ring 3 to press the polishing pad 101 and the pressure applied to the substrate W that is pressed against the polishing pad 101, a desired distribution of polishing pressure can be obtained over the surface of the substrate W and the outside area of the substrate W. i.e., the central portion (portion C1 shown in FIG. 8), the central portion to the intermediate portion (C2), the intermediate portion (C3), the peripheral portion (C4), and the retainer ring 3 lying outside the substrate W.

In the portions of the substrate W which lie underneath the pressure chambers 22, 23, there are a portion to which pressure is applied via the elastic pad 4 from the pressurized fluid and a portion, such as a portion corresponding to an opening 41, to which pressure of the pressurized fluid is directly applied. The pressures applied to these portions may be equal or different from each other. The elastic pad 4 around the opening 41 adheres tightly to a back surface of the substrate W during polishing. Therefore, almost no pressurized fluid leaks out of the pressure chambers 22, 23.

As previously discussed, the substrate W is divided into four concentric circular and annular portions (C1 to C4), and the respective portions (pressure areas) can be pressed at independent pressures. The polishing rate depends on the pressure applied to the substrate W to press the polishing surface. As described above, the pressure on each divisional portion of the substrate can be controlled independently, whereby plating rates of four portions (C1 to C4) of the substrate W can be controlled independently. Accordingly, even if there is a variation in thickness of a thin film along a radial direction of the substrate W to be polished, shortage or excess of polishing can be avoided over the surface of the substrate in its entirety.

In particular, even when a thickness of a film to be polished surface of the substrate W varies in the radial direction of the substrate W, the pressure of a portion of the substrate W, having a relatively large film thickness, on a polishing surface can be made higher than the pressure of a portion of the substrate W, having a relatively small film thickness, on the polishing surface by making the pressures of those pressure chambers of the pressure chambers 22-25, which lie over the portion of the substrate W having a relatively large film thickness, higher than the pressures of the other pressure chambers, or by making the pressures of those pressure chambers, which lie over the portion of the substrate W having a relatively small film thickness, lower than the pressures of the other pressure chambers. The polishing rate of the portion of the substrate W having a relatively large film thickness can thus be selectively raised. This makes it possible to polish the surface of the substrate W without excess or shortage of polishing over the entire surface irrespective of the thickness distribution of a surface film upon its formation.

Rounded edge due to over-polishing, which could occur in an edge portion of the substrate W, can be prevented by controlling the pressing force of the retainer ring 3. When there is a large variation in a thickness of a film to be polished in the edge portion of the substrate W, the polishing rate of the edge portion can be controlled by making the pressing force of the retainer ring 3 high or low intentionally. When the pressurized fluid is supplied to the pressure chambers 22 to 25, the chucking plate 6 receives an upward force. In this embodiment, the pressurized fluid is supplied via the fluid passage 31 into the pressure chamber 21 so as to prevent the chucking plate 6 from being elevated by the force applied from the pressure chambers 22 to 25.

Polishing of the substrate W is thus performed with the pressure, applied to the retainer ring 3, being appropriately adjusted by the top ring air cylinder 111 and with the pressures, applied to the divisional portions of the substrate W, being appropriately adjusted by the pressurized air supplied to the pressure chambers 22 to 25.

As described above, the pressure on the substrate W can be controlled by independently controlling the pressures in the pressure chambers 22, 23, the pressure chamber 24 in the center bag 8, and the pressure chamber 25 in the ring tube 9. Further according to this embodiment, pressure-controllable areas of the substrate W can be easily changed by changing position and size of the center bag 8 and the ring tube 9.

A thickness distribution of a film formed on a surface of a substrate may vary depending on a type of film-forming method or film-forming apparatus used. According to this embodiment, the position and the size of the pressure chambers for applying pressure to the substrate can be changed simply by replacing the center bag 8 and the center bag holder 82, or the ring tube 9 and the ring tube holder 92. Therefore, the position and range of pressure control on the substrate can be easily changed according to a thickness distribution of a film, to be polished, at a low cost simply by changing only a part of the top ring 1. In other words, this makes it possible to deal with a change in thickness distribution of a film on the surface of the substrate easily at a low cost. Changing the shape and position of the center bag 8 or the ring tube 9 results in a change in size of the pressure chamber 22, lying between the center bag 8 and the ring tube 9, and a change in size of the pressure chamber 23 surrounding the ring tube 9.

The operations of the substrate processing apparatus will now be described.

First; the substrate cassette 204, which stores a large number of substrates W shown in FIG. 1B each having the copper film 307 formed on the surface, is mounted on the loading and unloading stage. One substrate is removed from the substrate cassette 204 by the transport robot 202 and placed onto the substrate station 206. The transport robot 208 receives the substrate from the substrate station 206 and, after reversing the substrate as necessary, transfers the substrate to the rotary transporter 210. The rotary transporter 210 is then rotated horizontally, and the substrate, supported by the rotary transporter 210, is held by the top ring 1 of one of the two electrochemical mechanical polishing apparatuses 250.

Thereafter, the substrate, held by the top ring 1, is moved to a polishing position above the polishing table 100. The top ring 1 is then lowered to press the substrate against the polishing surface of the polishing pad 101 at predetermined pressure of not more than about 70 hPa (1 psi). While supplying an electrolytic liquid 50 to the polishing pad 101, the voltage is applied by the power source 252 between the first electrode 254 and the conductive film of the substrate, i.e., the copper film 307, to perform polishing (first polishing) of the conductive film. Holding of the substrate, e.g., by vacuum attraction, may be released during polishing of the substrate with the polishing pad 101.

In the first polishing by the electrochemical mechanical polishing apparatus 250, the conductive film, i.e., the copper film 307 (and the seed film 306), is polished so that the average thickness of the remaining conductive film becomes not more than 300 nm and the distribution of the thickness of the remaining conductive film in the substrate surface becomes not more than 150 nm. For this purpose, polishing of the conductive film is carried out while detecting the distribution of the thickness of the copper film 307 (and the seed film 306) in the substrate surface with the ITM 226, such as an eddy current sensor, and regulating with the control section 400 the polishing pressures in the divisional portions (pressure areas) C1 to C4, shown in FIG. 8. By thus employing electrochemical mechanical polishing, which generally causes little damage to interconnects, etc., in polishing of a substrate, and carrying out polishing and removal of most of an interconnect metal film formed outside interconnect recesses, the interconnect metal film accounting for the major proportion of the overall polishing amount, by electrochemical mechanical polishing, damage to the interconnect structure of the substrate caused by polishing can be significantly reduced.

During the polishing, the flow rates and the temperatures of the flows of the electrolytic liquid 50, which are passed through the plurality of electrolytic liquid supply lines 142 and supplied from the electrolytic liquid supply orifices 140 of the electrolytic liquid supply nozzle 102 to the polishing pad 101, are controlled, according to necessity. Thus, based on a difference between the thickness distribution of the conductive film [copper film 307 (and seed film 306)] during polishing and an intended thickness distribution of the conductive film, the flow rates and the temperatures of the flows of the electrolytic liquid, which are supplied from the electrolytic liquid supply orifices 140 to the polishing pad 101, are independently controlled so as to control the polishing rate distribution in the surface of the polishing object.

The relative movement speed between the polishing pad 101 and the substrate W may also be controlled. The rotational speed of the polishing pad 101 may be controlled, e.g., in the range of 20 to 40 rpm, and the rotational speed of the substrate W may be controlled, e.g., in the range of 50 to 100 rpm. It is also possible to rotate the substrate W in a direction opposite to the rotating direction of the polishing pad 101, according to necessity, or to pivot the substrate W in the radial direction of the polishing pad 101, according to necessity.

After completion of the first polishing in the one electrochemical mechanical polishing apparatus 250, the polished surface and the back surface of the substrate are cleaned (rinsed), e.g., with pure water and dried, according to necessity, and the substrate is then transported via the rotary transporter 210 to the other electrochemical mechanical polishing apparatus 250 and held by the top ring 1 of this apparatus. In the electrochemical mechanical polishing apparatus 250 which has carried out the first polishing, on the other hand, conditioning of the polishing surface of the polishing pad 101 with the dresser 218 is carried out to prepare for the next polishing.

The substrate held by the top ring 1 is moved to a polishing position above the polishing table 100. The top ring 1 is then lowered to press the substrate on the polishing surface of the polishing pad 101. While supplying the electrolytic liquid 50 to the polishing pad 101, a voltage is applied from the power source 252 to between the first electrode 254 and the surface conductive film of the substrate, i.e., the copper film 307, to carry out polishing of the remaining conductive film which has not been removed by the first polishing, i.e., the copper film 307 (and the seed film 306) on the barrier film 305, thereby exposing the barrier film 305.

The polishing in the electrochemical mechanical polishing apparatus 250 is carried out under such conditions that the polishing rate of the conductive film decreases with distance from the center of the substrate. Thus, while detecting the distribution in the substrate surface of the thickness of the remaining conductive film, i.e., the copper film 307 (and the seed film 306), with the ITM 226 such as an eddy current sensor, the remaining conductive film is polished in such a manner that the polishing rate of the conductive film is higher in an inner region of the substrate surface. For this purpose, the polishing pressures in the portions (pressing areas) C1 to C4 shown in FIG. 8 is controlled by the control section 400 in such a manner that the polishing pressure concentrically decreases in the order of: the central portion (C1) of the substrate W—the inner intermediate portion (C2)— the outer intermediate portion (C3)— the peripheral portion (C4), with the difference in polishing pressure between the central portion (C1) and the peripheral portion (C4) being, e.g., in the range of 0.01 (about 0.7 hPa) to 0.5 (about 35 hPa).

During the polishing, as in the above-described first polishing, the flow rates and the temperatures of the flows of the electrolytic liquid 50, which are passed through the plurality of electrolytic liquid supply lines 142 and supplied from the electrolytic liquid supply orifices 140 of the electrolytic liquid supply nozzle 102 to the polishing pad 101, are controlled, according to necessity. Thus, based on a difference between the thickness distribution of the conductive film [copper film 307 (and seed film 306)] during polishing and an intended thickness distribution of the conductive film, the flow rates and the temperatures of the flows of the electrolytic liquid, which are supplied from the electrolytic liquid supply orifices 140 to the polishing pad 101, are independently controlled so as to control the polishing rate distribution in the surface of the polishing object.

The relative movement speed between the polishing pad 101 and the substrate W may also be controlled. The rotational speed of the polishing pad 101 may be controlled, e.g., in the range of 20 to 40 rpm, and the rotational speed of the substrate W may be controlled, e.g., in the range of 50 to 100 rpm. It is also possible to rotate the substrate W in a direction opposite to the rotating direction of the polishing pad 101, according to necessity, or to pivot the substrate W in the radial direction of the polishing pad 101, according to necessity.

The second polishing of the conductive film is carried out in such a manner that the barrier film 305, underlying the conductive film [copper film 307 (and seed film 306)], becomes gradually exposed from the center toward the periphery of the substrate W, as shown in FIG. 14. Finally, the conductive film on the barrier film 305 is completely polished away. By thus polishing the conductive film of a substrate in the second polishing in such a manner that the barrier film 305, underlying the conductive film [copper film 307 (and seed film 306)], becomes gradually exposed from the center toward the periphery of the substrate, it becomes possible to prevent the conductive film in an electrically-insulated state from not being polished away and remaining on the barrier film 305.

The thickness of the conductive film, i.e., the copper film 307 (and the seed film 306), remaining on the peripheral portion of the substrate W upon removal of the conductive film from the central portion of the substrate and exposure of the barrier film 305, as shown in FIG. 14, is, e.g., not more than 100 nm, preferably not more than 50 nm, more preferably not more than 20 nm. This can shorten a period of time during which the conductive film, such as an interconnect metal film, is exposed to an electrolytic liquid, thereby preventing excessive polishing of the conductive film (interconnect metal film) embedded, e.g., in trenches.

It is preferred to use an electrolytic liquid which, when the barrier film becomes gradually exposed from the center toward the periphery of the polishing object during polishing, provides an electrolytic etching rate of not more than 50 nm/min for the conductive film, i.e., the copper film 307 (and the seed film 306). The electrolytic etching rate refers to the rate of etching as carried out by applying an electric potential to a conductive film in an electrolytic liquid without mechanical polishing involved. By thus carrying out polishing of a conductive film, such as an interconnect metal, at an electrolytic etching rate of not more than 50 nm/min, excessive polishing of the conductive film (interconnect metal film) embedded, e.g., in trenches, due to its exposure to an electrolytic liquid, can be prevented.

The polishing rate of the remaining conductive film in the period of time when the average thickness of that film is not more than 200 nm, may be not more than ½ of the polishing rate of the conductive film in the period of time when the average thickness of that film is not less than 200 nm. This can also prevent excessive polishing of the conductive film (interconnect metal film) embedded, e.g., in trenches when the interconnect metal film is used as the conductive film.

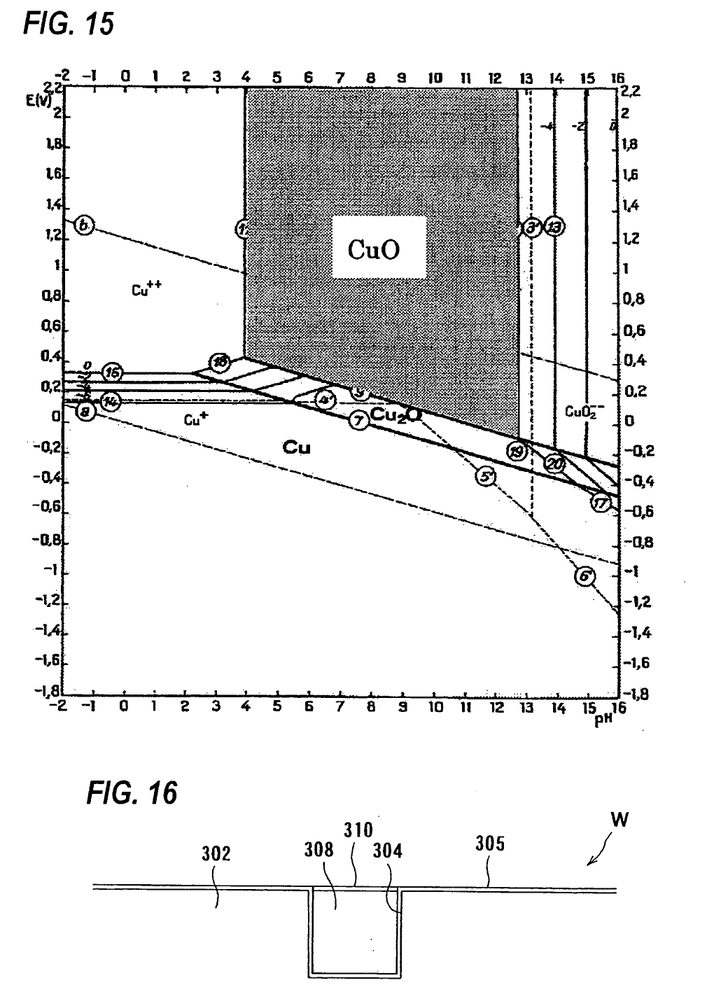

An electrolytic liquid for use in polishing of copper preferably has a pH within a pH range, as specified in the copper potential-pH diagram (Pourbaix diagram) shown in FIG. 15, in which a passive oxide film (CuO, Cu₂O) is formed in copper. The pH range of an aqueous electrolytic liquid in which a passive copper oxide film (CuO, Cu₂O) will be formed, can be generally specified by the potential-pH diagram (Pourbaix diagram) which defines regions, in which different chemical species (copper) will be present in water, on the electrode potential-pH two-dimensional coordinate system. Though the pH range specified by the diagram of FIG. 15 is 4 to 12.5, the pH range varies depending on the type of the electrolyte used in the electrolytic liquid. The potential-pH diagram is prepared based on thermodynamic data (theory of equilibrium). Excessive electrolytic etching of interconnects 308 (see FIG. 1C) can be prevented by forming a passive oxide film 310 on the surface of the conductive film, which is embedded in trenches 304 and is to form the interconnects 308, and covering the conductive film with the passive oxide film 310 when an barrier film 305 becomes exposed, as shown in FIG. 16. From the viewpoint of preventing electrolytic etching of copper, the pH of the electrolytic liquid is preferably in a weakly-acidic range, e.g., a pH range of 3 to 4.5, rather than a strongly-acidic range in which copper will be actively-dissolved as Cu²⁺.

An exemplary electrolytic liquid contains a corrosion inhibitor, abrasive grains, a complexing agent, a pH adjuster, a surfactant, etc. For the purpose of further protecting a passive oxide film, it is preferred to use a corrosion inhibitor composed of a compound containing N, S or P which easily combines with copper. Examples of the N-containing compound include benzotriazole and its derivatives, (benz)imidazole and its derivatives, anionic surfactants such as an aliphatic alkanol amide, and polymers such as polyethylenimine and polyacrylamide. Examples of the S-containing compound include thiosalicylic acid, 6-dibutylamino-1,3,5-triazine-2,4-dithiol, etc. Examples of the P-containing compound include anionic surfactants, such as a phosphoric acid ester.

An electrolyte for use in the electrolytic liquid preferably is a compound capable of combining with copper. Examples of such electrolyte include oxalic acid, malonic acid, succinic acid, glutaric acid, maleic acid, citric acid, glycolic acid, lactic acid, gluconic acid, malic acid, ascorbic acid, pyruvic acid, glyoxylic acid, acetic acid, propionic acid, butyric acid, aconitic acid, tartaric acid, phosphoric acid, amino acids (e.g., glycine), ethylene diamine, ethylene diamine tertaacetic acid, etc.

Examples of the abrasive grains contained in the electrolytic liquid include silica (fumed silica, colloidal silica), aluminum oxide, zirconium oxide, cerium oxide, titanium oxide, manganese oxide, etc.

Another exemplary electrolytic liquid contains 2 to 80% by weight of at least one organic acid, 2 to 20% by weight of at least one strong acid having a sulfonic acid group, 0.01 to 1% by weight of a corrosion inhibitor, 0.01 to 1% by weight of a water-soluble polymeric compound, 0.01 to 2% by weight of abrasive grains, and 0.01 to 1% by weight of a surfactant, and has a pH adjusted to 3 to 4.5.

Examples of the organic acid include acetic acid, propionic acid, oxalic acid, malonic acid, succinic acid, glutaric acid, adipic acid, maleic acid, fumaric acid, citric acid, aconitic acid, glyoxylic acid, glycolic acid, lactic acid, gluconic acid, malic acid and tartaric acid. Examples of the strong acid having a sulfonic acid group include benzenesulfonic acid, methanesulfonic acid, taurine, cysteic acid, an alkylbenzene sulfonic acid having 1 to 6 carbons in the alkyl group, trifluoromethanesulfonic acid and fluorosulfonic acid.

Examples of the corrosion inhibitor include benzotriazole and its derivatives. Examples of the water-soluble polymeric compound include polyethylene glycol, polyisopropyl acrylamide, polydimethyl acrylamide, polymethacrylamide, polymethoxyethylene, polyvinyl alcohol, hydroxyethyl cellulose, carboxymethyl cellulose, polyacrylic acid or a salt thereof, polymethacrylic acid or a salt thereof, and polyvinylpyrrolidone. Examples of the abrasive grains include those of colloidal silica or fumed silica, having a primary particle size of not less than 10 nm.

The voltage applied between the first electrode 254 and the second electrode 256, i.e., between the first electrode 254 and the conductive film, such as the copper film 307, when the average thickness of the remaining conductive film is not more than 200 mm, is preferably lower than the voltage applied between the first electrode 254 and the second electrode 256, i.e., between the first electrode 254 and the conductive film, such as the copper film 307, when the average thickness of the remaining conductive film is not less than 200 nm. The former voltage is, for example, not more than 4-5 V.

FIG. 17 shows the relationship between current value and electrode potential during polishing. The zone A shown in FIG. 17, in which there is a temporary drop in current value and which corresponds to the electrode potential range of 0.8 to 1.2 (V vs. Ag/AgCl), is the zone of the formation of a passive film (passive oxide film) on the surface of the conductive film. The passive film on the surface of the conductive film is considered to have been destroyed in the zone with the higher electrode potential range than the zone A range. Thus, when the average thickness of the conductive film is not less than 200 mm, polishing of the conductive film may be carried out by applying a voltage, at which the passive film is destroyed (voltage higher than the zone A potential range), so as to increase the polishing rate, whereas when the average thickness of the conductive film is not more than 200 nm, polishing of the conductive film may be carried out by applying a voltage, falling within the zone A potential range, so as to form the passive film on the surface of the conductive film and cover the surface with the passive film. This can prevent excessive electrolytic etching of the conductive film.

The voltage applied from the power source 252 to between the first electrode 254 and the second electrode 256, i.e., between the first electrode 252 and the conductive film, such as the copper film 307, in the period from the beginning to the completion of exposure of the barrier film 305 is preferably not more than the corrosion potential of the conductive film, such as the copper film 307. This can suppress corrosion of the conductive film, thereby preventing excessive polishing of the conductive film (interconnect metal film) embedded, e.g., in trenches.

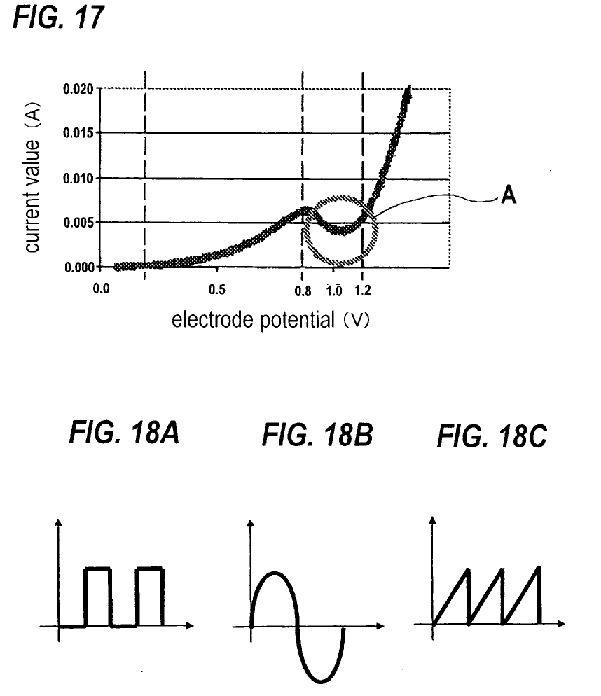

The waveform of the voltage applied from the power source 252 to between the first electrode 254 and the second electrode 256, i.e., between the first electrode 254 and the conductive film, such as the copper film 307, in the period from the beginning to the completion of exposure of the barrier film 305 preferably is a rectangular waveform as shown in FIG. 18A, a sine waveform as shown in FIG. 18B, or a ramp waveform as shown in FIG. 18C.

The use of a waveform with a temporary decrease in voltage, such as a rectangular waveform or a ramp waveform, can prevent rapid dissolution of the conductive film 307, thereby suppressing surface roughening and excessive polishing of the conductive film (interconnect metal film). The frequency of the voltage is preferably set so as not to synchronize with the cycle of a through-hole 101a of the polishing pad 101, passing a particular portion of the conductive film 307. This is because if the voltage frequency synchronizes with the above cycle, there will be processed/non-processed portions in the conductive film, resulting in a large variation in the thickness distribution of the conductive film.

When terminating polishing, it is preferred to first stop the application of voltage and then terminate the supply of the electrolytic liquid in order not to impair the polishing performance.

After completion of the second polishing in the electrochemical mechanical polishing apparatus 250, the substrate is transported to the cleaning unit 214, via the rotary transporter 210 and the transport robot 208, and after reversing the substrate as necessary. In the electrochemical mechanical polishing apparatus 250 after the polishing, conditioning of the polishing surface of the polishing pad 101 with the dresser 218 is carried out to prepare for the next polishing.

The substrate surface is cleaned (rinsed) in the cleaning unit 214, and the substrate after cleaning is transported by the transport robot 208 to the substrate station 206 and placed on it. The transport robot 202 (or 208) takes the substrate out of the substrate station 206, and transports the substrate to the drying unit 212, for example having a pen sponge for cleaning of the upper surface and a spin-drying function, where the substrate is cleaned and dried. Thereafter, the dried substrate is returned by the transport robot 202 to the substrate cassette 204.

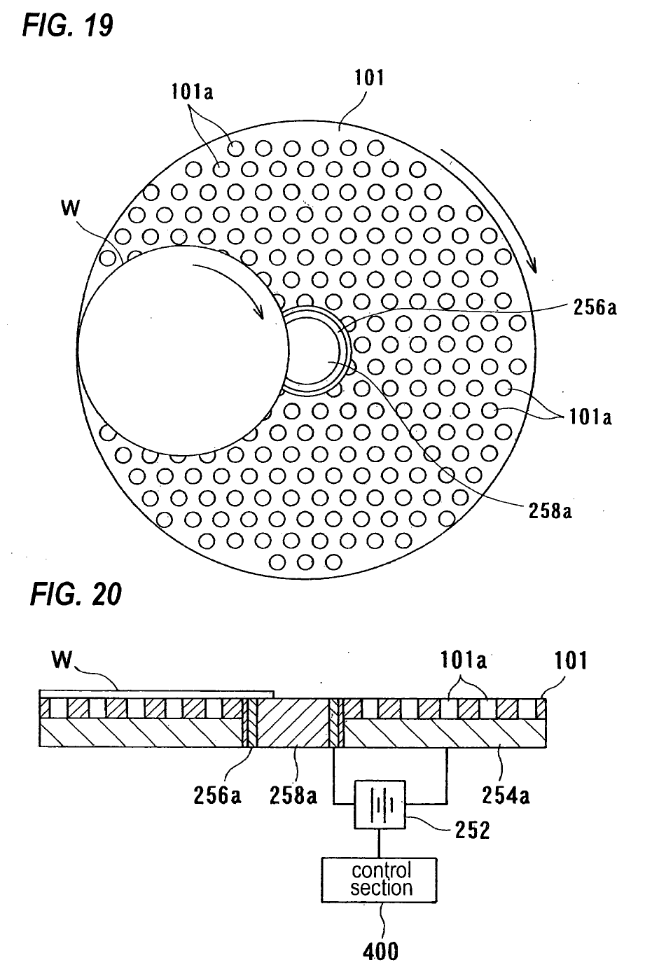

FIGS. 19 and 20 show another polishing table. According to this embodiment, on an upper surface of a polishing table 100 (see FIG. 6) are disposed a ring-shaped first electrode (cathode) 254a connected to one pole of a power source 252 and a ring-shaped second electrode (anode) 256a connected to the other pole of the power source 252, the electrodes being electrically insulated from each other by an insulator 258a. The entire surface of the first electrode 254a is covered with a polishing pad 101, having a large number of through-holes 101a, whose upper surface serves as a polishing surface. The polishing surface is approximately flush with the upper surfaces of the second electrode 256a and the insulator 258a.

In this embodiment, the second electrode 256a is disposed such that it extends continuously in a ring along the inner circumference of the first electrode 254a and is embedded in the insulator 258a. It is also possible to divide the second electrode 254 and connect each of the divided electrodes to the power source 252, or to use a pad-like conductive member as the second electrode 256.

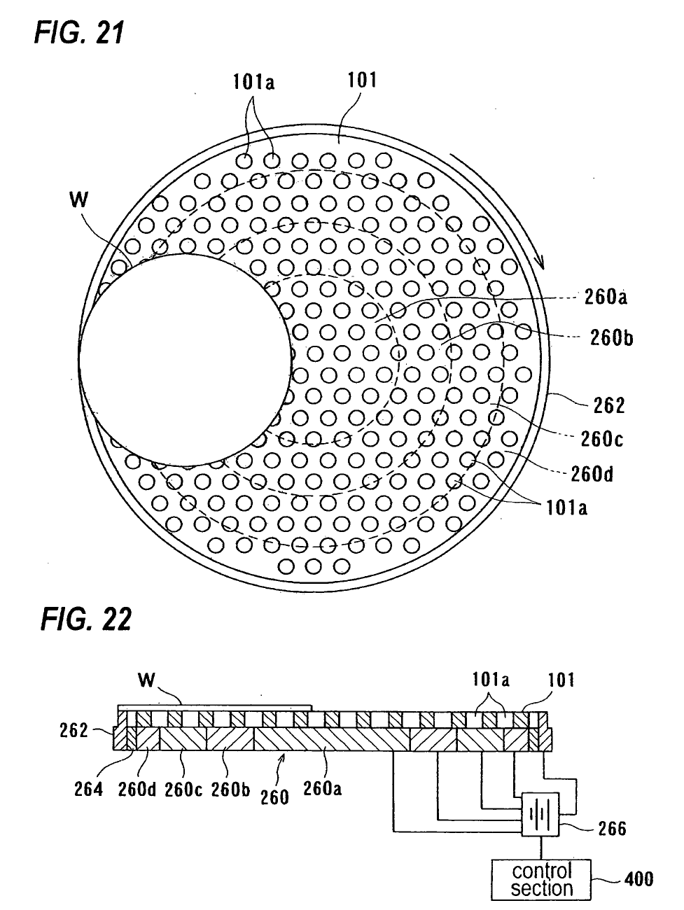

FIGS. 21 and 22 show another polishing table. According to this embodiment, on the upper surface of a polishing table 100 (see FIG. 6) are disposed a first electrode (cathode) 260, comprised of a plurality of (four) concentrically-divided electrodes 260a to 260d, and a ring-shaped second electrode (anode) 262 surrounding the circumference of the first electrode 262, the first and second electrodes being electrically insulated from each other by an insulator 264. The divisional electrodes 260a to 260d of the first electrode 260 are individually connected to one pole of a power source 266, and the second electrode 262 is connected to the other pole of the power source 266. The entire surface of the first electrode 260 is covered with a polishing pad 101, having a large number of through-holes 101a, whose upper surface serves as a polishing surface. The polishing surface is approximately flush with the upper surface of the second electrode 262. The power source 266 controls the electrode potentials of the divided electrodes 260a to 260d based on a signal from the control section 400.

In operation, the conductive film, i.e., the copper film 307 (and the seed film 306), is polished so that the average thickness of the remaining conductive film becomes not more than 300 nm and the distribution of the thickness of the remaining conductive film in the substrate surface becomes not more than 150 nm. For this purpose, polishing of the conductive film is carried out while detecting the distribution of the thickness of the copper film 307 (and the seed film 306) in the substrate surface with the ITM 226, such as an eddy current sensor, and individually regulating with the control section 400 the electric potentials of the divided electrodes 260a to 260d.

Thereafter, the remaining conductive, i.e., the copper film 307 (and the seed film 306), is polished while detecting the distribution of the thickness of the copper film 307 (and the seed film 306) in the substrate surface with the ITM 226, such as an eddy current sensor, and controlling with the control section 400 the electric potentials of the divided electrodes 260a to 260d, e.g., with a potential difference in the range of 0.01 to 0.5 V, so that the polishing rate decreases with distance from the center of the substrate.

The polishing of the conductive film is thus carried out in such a manner that the barrier film 305, underlying the conductive film [copper film 307 (and seed film 306)], becomes gradually exposed from the center toward the periphery of the substrate W, as shown in FIG. 14. Finally, the conductive film on the barrier film 305 is completely polished away.

The end point of polishing may be detected by monitoring a change in an eddy current generated by an eddy current sensor and detecting complete removal of the conductive film [copper film 307 (and seed film 306)] on the barrier film 305. As shown in FIG. 6, the sensor coil 228 of the ITM 226, such as an eddy current sensor, is disposed, e.g., under the polishing pad 101 of the polishing table 100. The end point of polishing may also be detected by utilizing a difference in electrode potential between the conductive film and the barrier film, and monitoring a change in electrode potential with a reference electrode. The reference electrode is preferably present in the vicinity of a polishing object, and may be disposed in the interior of the retainer ring or on the circumferential surface of the retainer ring, or may be allowed to approach a polishing object from the polishing table side through a through-hole of the polishing pad.

When the polishing table shown in FIGS. 21 and 22 is used, it is not always necessary to use the top ring 1 shown in detail in FIGS. 7 and 8, having the plurality of portions (pressing areas) C1 to C4 which are individually adjustable. However, the use of both of them enables finer control. The electrolytic liquid is supplied to the polishing pad 101 preferably by using the electrolytic liquid supply nozzle 102 having the plurality of electrolytic liquid supply orifices 140 which are independently controllable for the flow rate and the temperature of the electrolytic liquid. This enables control of the distribution of polishing rate in the conductive film.

In this embodiment, the conductive film is first polished so that the average thickness of the remaining conductive film becomes not more than 300 nm and the distribution of the thickness of the remaining conductive film in the substrate surface becomes not more than 150 nm, and then the remaining conductive film is polished under such conditions that the polishing rate decreases with distance from the center of the substrate. Instead, it is also possible to polish the conductive film so that the average thickness of the remaining conductive film becomes not more than 300 nm and the thickness of the remaining conductive film increases with distance from the center of the substrate in the first polishing, and then polish the remaining conductive film under such conditions as to make the polishing rate uniform over the entire substrate surface.

Also by this method, polishing of the conductive film can be carried out in such a manner that the barrier film 305, underlying the conductive film [copper film 307 (and seed film 306)], becomes gradually exposed from the center toward the periphery of the substrate W, as shown in FIG. 14. Finally, the conductive film on the barrier film 305 can be completely polished away. The difference in the thickness of the remaining conductive film upon completion of the first polishing is, for example, not more than 100 nm, preferably not more than 50 nm, more preferably not more than 20 nm.

The conductive film [copper film 307 (and seed film 306)] may be polished under such conditions that the polishing rate decreases with distance from the center of the polishing object, with the difference in polishing rate between the center and the periphery of the polishing object being, for example, 100 nm/min and preferably not more than 50 nm/min.

In this embodiment, the substrate processing apparatus is provided with the two electrochemical mechanical polishing apparatuses, and the first polishing and the second polishing are carried out separately in the two electrochemical mechanical polishing apparatuses. However, in the case where the first polishing and the second polishing can be carried out, for example, with the use of the same electrolytic liquid and by changing the polishing pressure and/or the voltage applied between the first electrode and the second electrode (conductive film), it is possible to carry out the first polishing and the second polishing successively in one electrochemical mechanical polishing apparatus.

Though in this embodiment a substrate, such as a semiconductor wafer, is used as a polishing object, an applicable polishing object is, of course, not limited to a substrate such as a semiconductor wafer.

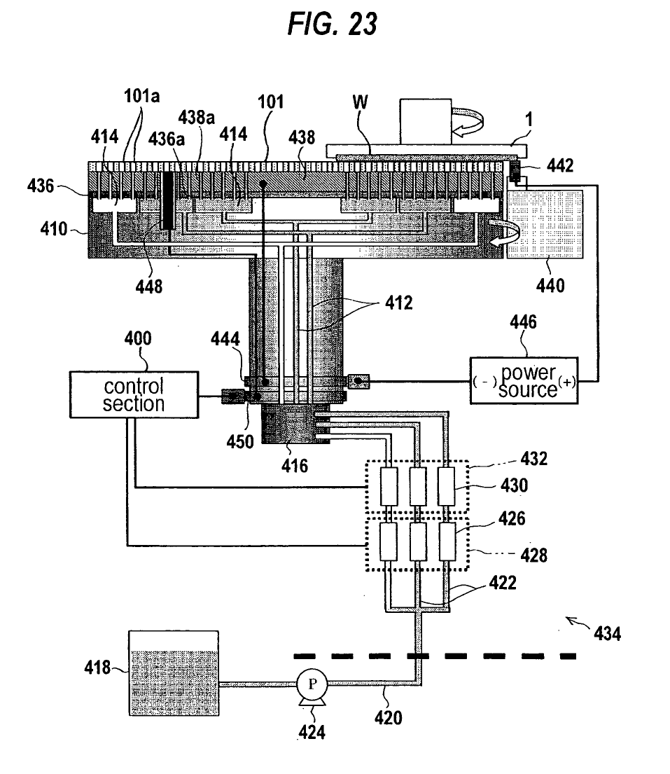

FIG. 23 shows yet another polishing table. As shown in FIG. 23, in this embodiment, three electrolytic liquid passages (electrolytic liquid supply passages) 412 are formed in the interior of a rotatable polishing table 410, and concentric electrolytic liquid storage chambers 414, individually communicating with the respective electrolytic liquid passages 412, are formed in the upper surface of the polishing table 410. The electrolytic liquid passages 412 in the polishing table 410 respectively communicate with three branched electrolytic liquid lines 422, branching off from a main electrolytic liquid line 420 that extends from an electrolytic liquid tank 418, via a rotary joint 416 coupled to the lower end of the shaft portion of the polishing table 410. The main electrolytic liquid line 420 is provided with a conveying pump 424, and also with a flow regulating section 428 having flow regulating valves 426 for regulating the flow rates of an electrolytic liquid flowing in the branched electrolytic liquid lines 422 and with a temperature regulating section 432 having heat exchangers 430 for regulating the temperatures of the electrolytic liquid flowing in the branched electrolytic liquid lines 422. An electrolytic liquid supply section 434 is thus constructed.

A disk-shaped first electrode (cathode) 438 is mounted via an insulating plate 436 on an upper surface of the polishing table 410, and a rod-like second electrode 442 is mounted on a support 440 disposed beside the polishing table 410. The insulating plate 436 and the first electrode 438 have a large number of through-holes 436a, 438a communicating with each other. The first electrode 438 is connected to one pole of a power source 446 via a slip ring 444 mounted to the lower end of the shaft portion of the polishing table 410, and the second electrode 442 is connected to the other pole of the power source 446. The upper surface of the first electrode 438 is entirely covered with a polishing pad 101, having a large number of through-holes 101a, whose upper surface serves as a polishing surface. The polishing surface is approximately flush with the upper surface of the second electrode 442.

A film thickness detection sensor 448 is embedded in the polishing table 410 with an upper end surface of the sensor 448 exposed on the surface of the first electrode 438. An output signal from the film thickness detection sensor 448 is inputted into the control section 400 via a slip ring 450 mounted to the lower end of the shaft portion of the polishing table 410 and, based on an output signal from the control section 400, the flow regulating valves 426 of the flow regulating section 428 and the heat exchangers 430 of the temperature regulating section 432 are controlled.

In operation, as with the above-described embodiment, a substrate W held by the top ring 1 is rotated while pressing the lower surface (front surface) of the substrate against the surface (polishing surface) of the rotating polishing pad 101, and an electrolytic liquid is supplied from the electrolytic liquid supply section 434 to the polishing pad 101 while applying a voltage from the power source 446 to between the first electrode 438 and a conductive film, such as the copper film 307, formed in the surface of the substrate W and in contact with the second electrode 442, thereby polishing the conductive film. During the polishing, the flow rates and the temperatures of the flows of the electrolytic liquid, which are passed through the electrolytic liquid passages (electrolytic liquid supply passages) 412 and supplied to the polishing pad 101, are controlled independently, e.g., based on a difference between the thickness distribution of the conductive film [copper film 307 (and seed film 306)] during polishing and an intended thickness distribution of the conductive film. This enables control of the distribution of polishing rate in the surface of the conductive film.

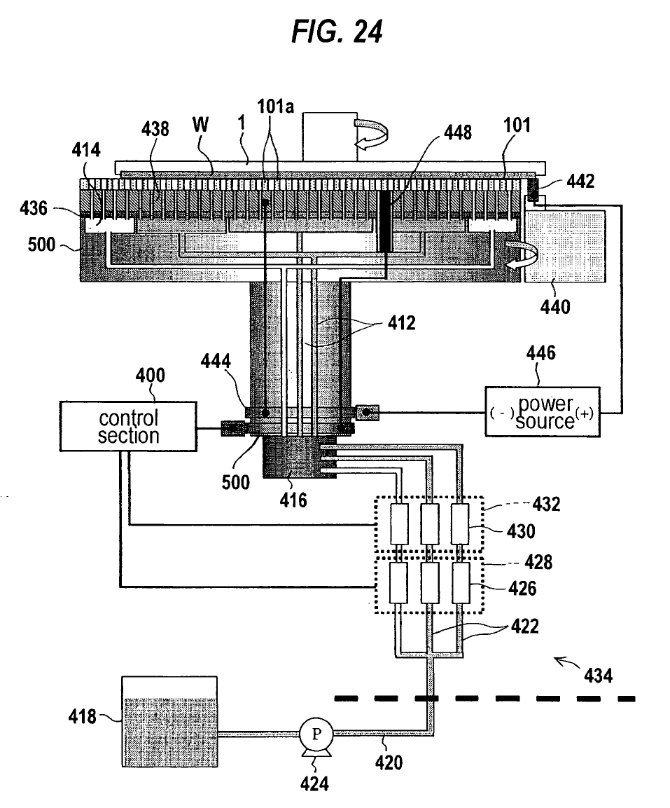

FIG. 24 shows the main portion of an electrochemical mechanical polishing apparatus according to another embodiment of the present invention. The apparatus of this embodiment employs a polishing table 500 whose diameter is slightly larger than the diameter of a substrate W held by the top ring 1. The polishing table 500 has substantially the same internal structure as the polishing table 410 shown in FIG. 23, though they differ in the overall size, and therefore the same reference numerals as shown in FIG. 23 are given to the same members or elements and a description thereof will be omitted.

The rotational center of the top ring 1 and the rotational center of the polishing table 500 are slightly displaced from each other so that when a substrate W is polished by rotating the top ring 1 and the polishing table 500, and pressing and rubbing the surface (lower surface) of the substrate W, held by the top ring 1, against the surface (polishing surface) of the polishing pad 101 covering the upper surface of the polishing table 500, the rotational center of the polishing table 500 will be kept covered with the substrate W held by the top ring 1.

This embodiment enables secure polishing of an entire surface of a substrate and effective use of an electrolytic liquid while achieving downsizing of electrochemical mechanical polishing apparatus.

It becomes possible with the present invention to expose a barrier film underlying a conductive film without leaving the conductive film in an electrically-insulated state on the barrier film. Accordingly, in the subsequent polishing process for the removal of the barrier film, remaining of the barrier film as well as the occurrence of dishing or erosion due to excessive etching of the conductive film (interconnect metal film), can be minimized.

### (Second Electrochemical Mechanical Polishing)

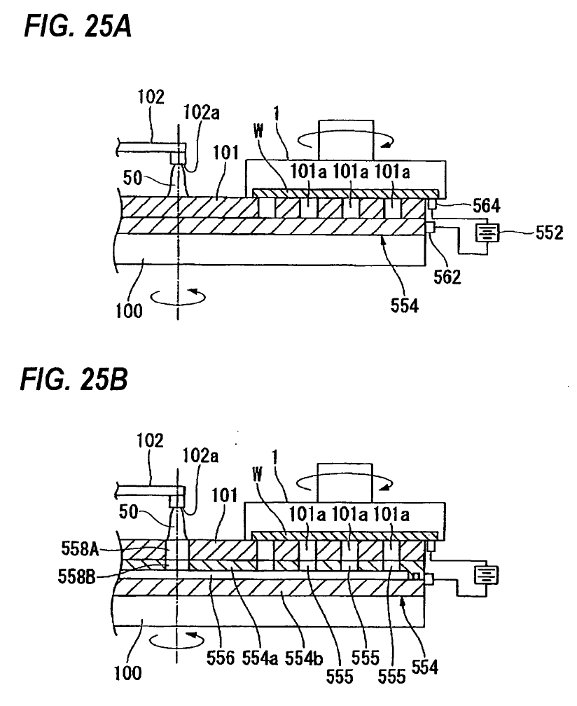

FIG. 25A is a vertical sectional view schematically showing the main portions of an electrochemical mechanical polishing apparatuses for use in the second electrochemical mechanical polishing. On the upper surface of a polishing table 100 is fixed a disk-shaped first electrode (support member) 554. The first electrode 554 is composed of a conductive material, such as a metal, an alloy, or a conductive plastic. On the upper surface of the first electrode 554 is mounted a polishing pad 101 whose upper surface serves as a polishing surface. The polishing table 100 is connected to a not-shown rotating mechanism, so that the polishing table 100 rotates together with the first electrode 554 and the polishing pad 101.

In this embodiment, an electrolytic liquid supply nozzle 102, having at its front end an electrolytic liquid supply orifice 102a, extends in the radial direction of the polishing pad 101. The electrolytic liquid supply orifice 102a is located above the center of the polishing pad 101, and an electrolytic liquid 50 from a not-shown electrolytic liquid supply source is supplied through the electrolytic liquid supply nozzle 102 to the center of the polishing pad 101. When the polishing pad 101 is rotating, the electrolytic liquid spreads outward and fills the through-holes 101a of the polishing pad 101 and the space between the top ring 1 and the polishing pad 101.

The first electrode (support member) 554 is connected to the negative pole of a power source 552 and serves as a cathode (counter electrode). A roller, a brush, or the like is used as an electrical contact between a conducting wire extending from the power source 552 and the first electrode (cathode) 554. For example, an electrical contact 562 may be in contact with a side surface of the support member 554, as shown in FIG. 25A. The electrical contact 562 is preferably formed of a soft metal having a low resistivity, such as gold, silver, copper, platinum, palladium, etc.

Beside the polishing pad 101 is disposed a second electrode (voltage application point) 564 connected to the positive pole of the power source 552. The top ring 1 brings a substrate W into contact with the polishing surface of the polishing pad 101 with part of the substrate W lying laterally outside the polishing pad 10. A region of the lower surface of the substrate W, corresponding to the peripheral portion C4 (see FIG. 8) of the top ring 1, comes into contact with the feeding electrode 564, so that a voltage is applied from the feeding electrode 564 to a conductive film 66 of the substrate W. It is also possible to apply a voltage from the feeding electrode 564 via a retainer ring to the conductive film 66 of the substrate W. The first electrode (cathode) 554 and the conductive film 66 of the substrate W are to be electrically connected via the electrolytic liquid filled in the through-holes 101a of the polishing pad 101.

FIG. 25B is a vertical sectional view schematically showing the main portions of another electrochemical mechanical polishing apparatuses. The first electrode (support member) 554 of this electrochemical mechanical polishing apparatuses is basically comprised of a disk-shaped base 554b and a lid 554a covering the upper surface of the base 554b. As described above, because the first electrode 554 serves as a cathode, at least one of the lid 554a and the base 554b is composed of a conductive material.

The lid 554a of the support member 554 has through-holes 555 at the same positions as the through-holes 101a of the polishing pad 101. The lid 554a also has in the lower surface a plurality of communicating grooves 556 that connect the through-holes 555 to each other. It is also possible to provide communicating grooves in the upper surface of the base 554b. A first electrolytic liquid receiving inlet 558A, vertically penetrating through the polishing pad 101, is formed in the center of the polishing pad 101. Further, a second electrolytic liquid receiving inlet 558B is formed in the lid 554a at the same position as the first electrolytic liquid receiving inlet 558A. The second electrolytic liquid receiving inlet 558B communicates with the above-described communicating grooves 556.

With this construction, the electrolytic liquid, which has been supplied from the electrolytic liquid supply orifice 102a of the electrolytic liquid supply nozzle 102, flows through the first electrolytic liquid receiving inlet 558A, the second electrolytic liquid receiving inlet 558B, the communicating grooves 556 and the through-holes 555 in this order, and reaches the through-holes 101a. Upward flows of the electrolytic liquid toward the polishing surface are created in the through-holes 101a, whereby the electrolytic liquid is supplied to the polishing surface.

An electrochemical mechanical polishing method according to this embodiment will now be described.

FIG. 3 illustrates a substrate before polishing. A description will be first made of the film structure of the substrate W. An insulating film (interlevel dielectric film) 62 of a so-called low-k material or an insulating material, such as SiO₂, SiOF or SiOC, is formed in the surface of the substrate W, e.g., comprising silicon. Interconnect recesses 63, such as via holes and trenches, are formed in the surface of the insulating film 62. On the insulating film 62, including the portions inside the interconnect recesses 63, is formed a barrier film 64 of, e.g., titanium, tantalum, tungsten, ruthenium and/or an alloy thereof, having a thickness of about 10 nm. The barrier film 64 is provided to prevent diffusion of the metal material of the below-described conductive film 66 into the substrate W and to enhance the adhesion between the conductive film 66 and the insulating film 62. The conductive film 66 of tungsten, having a thickness of about 500 to 600 nm, is formed on the barrier film 64. When electroplating is used to form the conductive film 66, a seed film (not shown), which serves as an electrode during electroplating, is previously formed on a surface of the barrier film 64. Recesses 67 having a height of about 300 nm and a width of about 100 μm, reflecting the interconnect recesses 63 in the insulating film 62, are formed in the surface of the conductive film 66. Besides tungsten, other conductive metal materials, such as aluminum, copper, silver, gold, and an alloy thereof, can be used for the conductive film 66.

Only the conductive film 66 embedded in the interconnect recesses 63 in the insulating film 62 is utilized as contact plugs or interconnects, and therefore the conductive film 66 formed outside the interconnect recesses 63 is unnecessary. The extra conductive film 66 is therefore removed by electrochemical mechanical polishing.

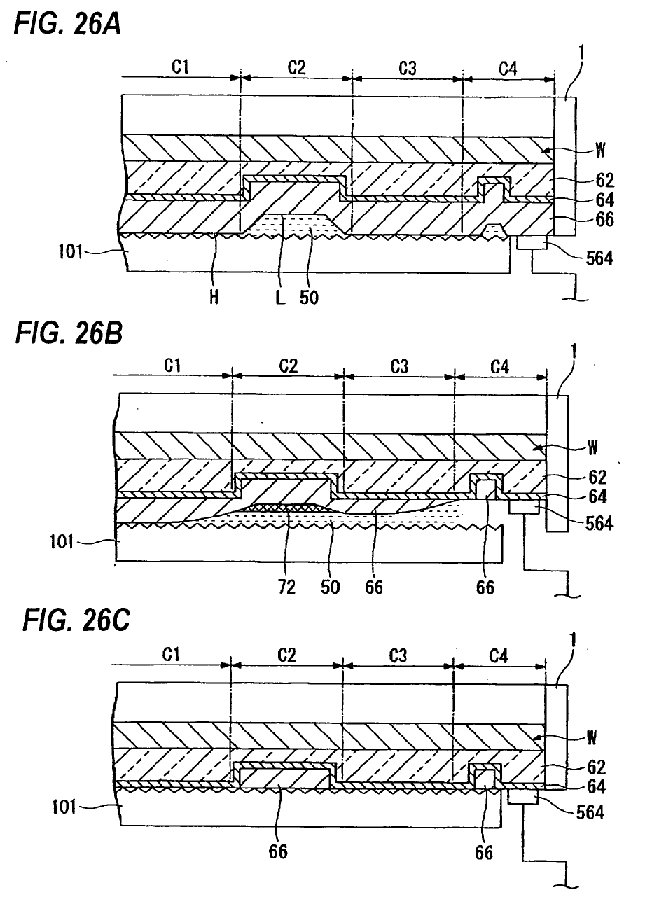

FIGS. 26A through 26C are diagrams illustrating electrochemical mechanical polishing. In FIGS. 26A through 26C, the substrate W is held with the conductive film 66 to be polished facing downwardly.

First, as shown in FIG. 26A, while applying a voltage to the surface conductive film 66 of the substrate W and keeping the electrolytic liquid 50 in contact with the conductive film 66, the substrate W and the polishing pad 101 are moved (rotated) relative to each other while pressing the surface of the substrate W against the polishing pad 101, thereby polishing the surface of the conductive film 66.

To produce a laminate of interconnects via the insulating film 62, it is necessary to flatten the surface of the substrate W while removing the extra conductive film 66. In electrochemical mechanical polishing, a protective film of an electrically insulating material is formed on the surface of the conductive film 66 by the application of a voltage to the conductive film 66. The protective film formed on the high portions H (outside the recesses 67) of the conductive film 66 is removed by contact with the polishing pad 101, whereby the conductive film 66 in the high portions H dissolves in the electrolytic liquid 50 and is thus removed. On the other hand, the conductive film on the low portions L (inside the recesses 67) is shielded by the protective film and does not dissolve in the electrolytic liquid 50, and thus the conductive film 66 on the low portions L is not polished. The surface level difference of the conductive film 66 is thus eliminated and the substrate W becomes flat, with the surface of the conductive film 66 being flush with the surface of the exposed barrier film 64.

The conventional common CMP process for polishing of tungsten utilizes the mechanism of forming a tungsten oxide film having a considerable thickness by the use of an acidic slurry having a pH<4, and mechanically polishing the tungsten oxide film. The CMP process therefore involves the problem of low polishing rate. The electrochemical mechanical polishing method of this embodiment, on the other hand, employs an electrolytic liquid having a pH of 4 to 10 and forms a protective film which is different from the conventional tungsten oxide film.

It is basically possible, in this embodiment, to use any electrolytic liquid insofar as the liquid has an appropriate electric conductivity (on the order of 1 mS/cm). The electrolytic liquid used may contain any main electrolyte insofar as the electrolyte provides the electrolytic liquid with an appropriate electric conductivity and will not roughen the surface of the conductive film. The electrolytic liquid preferably forms a complex or chelate with tungsten and promotes dissolution of tungsten, and thus preferably contains an organic acid. Examples of the organic acid include glycolic acid, pyrophosphoric acid, phosphoric acid, citric acid, malic acid, maleic acid, malonic acid, lactic acid, tartaric acid, succinic acid and salts of these acids, which may be used either singly or as a mixture of two or more. The electrolytic liquid preferably has a pH in the range of 4 to 10 in which tungsten will easily form a complex or chelate which is a soluble compound. An alkali metal salt or an alkaline earth metal salt can be used as a pH adjuster component in the electrolytic liquid. The use of an ammonium salt is preferred from the viewpoint of preventing metal contamination.

The electrolytic liquid used may contain an additive for forming an electrically insulating material. A primary amine polymer may be used as such an additive. Examples of the amine polymer include polyallylamine (polymer having only a primary amino group in the side chain; molecular weight 1,000-60,000), polyallylamine hydrochloride (molecular weight 1,000-60,000), allylamine hydrochloride-diallylamine hydrochloride copolymer (molecular weight 20,000-100,000), polyallylamine amidosulfate (molecular weight 12,000), allyl aminoacetate-diallylamine acetate copolymer (molecular weight 100,000), allylamine-dimethylallylamine copolymer (molecular weight 1000), partially methoxycarbonylated polyallylamine (molecular weight 15,000), partially methoxycarbonylated polyallylamine acetate (molecular weight 15,000), etc. Polyethylenimine (molecular weight 1,000-70,000), a primary amine polymer, may also be used. Polyethylenimine is a polymer having a branching structure and containing primary, secondary and tertiary amines in the molecule, and is effective because of the presence of primary amine.

The concentration of an additive for forming an electrically insulating material is preferably 0.01 to 5% by weight, more preferably 0.1 to 1% by weight, in the case of polyethylenimine. The electric current suppression effect (electrical insulation) is low when the concentration is lower than 0.01% by weight. On the other hand, an increase in the electric current suppression effect with an increase in the concentration of the additive tends to be smaller when the concentration is higher than 5% by weight. Such a high concentration is thus not necessary. The use of an additive for forming an electrically insulating material makes it possible to lower a voltage range which achieves high elimination of surface level difference, as will be described later. With reference to abrasive grains, the conventional common CMP needs to use abrasive grains in a concentration of at least 10%, whereas the use of abrasive grains even in a concentration of not more than 1% is sufficiently effective in this embodiment. A surfactant may be added to the electrolytic liquid in order to enhance dispersion of abrasive grains; if not added, however, that will not cause any significant problem because of the low concentration of abrasive grains. An exemplary electrolytic liquid in this embodiment contains ammonium citrate (pH 8).

The present inventors conducted an experiment on the polishing rate of tungsten in the following manner:

A polishing experiment was carried out by using an electrolytic polishing apparatus which can polish only a 40 mm-diameter portion of a substrate. This apparatus is designed to be capable of controlling the electrode potential of a metal film formed on the substrate, and polishes the metal film with a polishing pad attached to a rotating polishing table while applying a voltage. A polishing rate of about 50 to 150 nm/min can be obtained per a current density of 10 mA/cm² with this apparatus.

An electrochemical measurement system HZ-3000 (Hokuto Denko Corporation) was used for measurement of the electrode potential, and a silver/silver chloride electrode (Ag/AgCl) was used as a reference electrode. A foamed polyurethane pad [IC 1000 single-layer pad (X-Y groove), Nitta Haas Incorporated], having grid-like grooves in the surface, was used as the polishing pad.

Using this polishing apparatus, measurement of anode polarization was carried out (by increasing the electrode potential of the substrate) to determine the relationship between applied voltage and electric current flowing to the substrate.

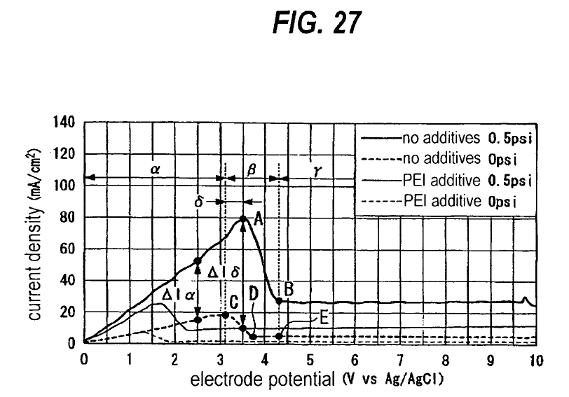

FIG. 27 is a graph showing the relationship between the potential of the conductive film and the current density. In FIG. 27, the ordinate represents the current density, i.e., the current per unit area of the surface to be polished of the substrate. The higher the current density, the larger is the amount of the conductive film that dissolves in an electrolytic liquid, that is, the higher is the polishing rate of the conductive film. In FIG. 27, the abscissa represents the electrode potential. In an actual polishing apparatus, however, because of cumbersome and complicated control of electrode potential, control is generally performed on a voltage applied between a substrate to be polished and a cathode. In the following description, therefore, the expression “applied voltage” will be used with reference to control of the electrode potential of a substrate. The applied voltage refers to “the potential difference between an anode and a cathode, involving the electrode potential of a substrate as the anode, the electrode potential of a first electrode (polishing table) as the cathode facing the substrate, a potential drop in an electrolytic liquid, etc.”

As the applied voltage is increased while keeping the conductive film in contact with an electrolytic liquid having a pH of 4 to 10, the current density rapidly changes at a certain voltage. As the voltage applied to the conductive film is increased from 0, the current density increases in proportion to the voltage until the voltage reaches a first change voltage at a first change point (e.g., point A), but the increase in the current density with the applied voltage turns into decrease at the first change voltage. The degree of decrease in the current density drops and the current density comes to take a constant value as the voltage is increased to a second change voltage at a second change point (e.g., point B). It is considered in this regard that a protective film, which is soluble in the electrolytic liquid, will be formed on the surface of the conductive film when a voltage, which is not more than the first change voltage, is applied to the conductive film, whereas a protective film, which is insoluble in the electrolytic liquid, will be formed on the surface of the conductive film when a voltage, which is not less than the second change voltage, is applied to the conductive film.

The present inventors discovered the fact that the above-described first and second change voltages change with the polishing pressure between a substrate W and a polishing pad. In FIG. 27, the bold solid line indicates the relationship in the case where the polishing pressure is 0.5 psi (finite value, corresponding to polishing of the higher portions in the irregular surface of the conductive film), and the bold broken line indicates the relationship in the case where the polishing pressure is 0 psi (zero pressure, corresponding to polishing of the low portions in the irregular surface of the conductive film). The point A denotes the first change point when the polishing pressure is the finite value, the point B (maximum voltage) denotes the second change point when the polishing pressure is the finite value, the point C (threshold voltage) denotes the first change point when the polishing pressure is 0, and the point D denotes the second change point when the polishing pressure is 0. The first and second change voltages and the current density increase with an increase in the polishing pressure. The first change voltage (voltage at point C) and the second change voltage (voltage at point D) when the polishing pressure is 0 are lower by about 0.5 V than the first change voltage (voltage at point A) and the second change voltage (voltage at point B) when the polishing pressure is the finite value, respectively.

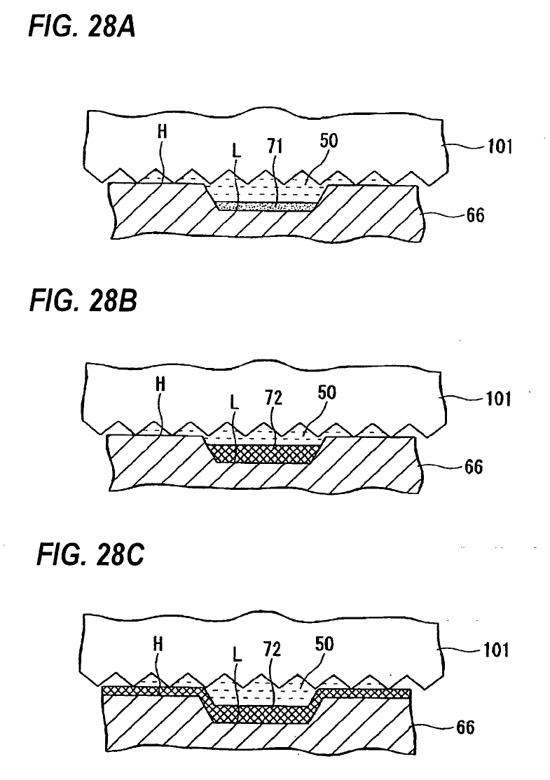

The range of applied voltage from 0 to the voltage at point C will now be called “region α”, the range from the voltage at point C to the voltage at point B will be called “region β”, and the range of applied voltage higher than the voltage at point B will be called “region γ”. The voltage range from the voltage at point C to the voltage at point A will be called “region δ”. FIGS. 28A through 28C are diagrams illustrating the formation of a protective film as observed when voltages, which are in the respective regions shown in FIG. 27, are applied to a conductive film, FIG. 28A illustrating the application of a voltage in the region α, FIG. 28B illustrating the application of a voltage in the region β, and FIG. 28C illustrating the application of a voltage in the region γ.

As shown in FIG. 28A, when a voltage in the region α is applied, a protective film 71, which is soluble in an electrolytic liquid 50, is formed. When the conductive film 66 has a surface level difference, the protective film 71 is completely polished away on the high portions H where the polishing pressure between a polishing pad 101 and the conductive film 66 is a finite value.

As shown in FIG. 28C, when a voltage in the region γ is applied, a protective film 72, which is insoluble in the electrolytic liquid 50, is formed. When the conductive film 66 has a surface level difference, the protective film 72 is not polished away and remains on the low portions L where the polishing pressure between the polishing pad 101 and the conductive film 66 is 0.

On the other hand, when a voltage in the region β is applied, the surface of the conductive film becomes an intermediate state between the above-described states, as shown in FIG. 28B. In particular, the soluble protective film is formed on the high portions H where the polishing pressure between the polishing pad 101 and the conductive film 66 is a finite value, and the protective film is polished away. On the other hand, the insoluble protective film 72 is formed on the low portions L where the polishing pressure between the polishing pad 101 and the conductive film 66 is 0, and the protective film 72 is not polished away and remains. Thus, if electrochemical mechanical polishing of the conductive film 66 is carried out while maintaining the applied voltage in the region β, dissolution of the conductive film 66 in the electrolytic liquid is promoted on the high portions H and suppressed on the low portions L. Accordingly, the surface level difference of the conductive film 66 can be eliminated quickly.

When a voltage in the region β is applied, the polishing rate of the high portions L covered with the protective film 72 is extremely low, and therefore dishing is less likely to occur in the conductive film 66. Further, the polishing rate of the high portions H can be controlled by adjusting the applied voltage. This makes it possible to use a low polishing pressure between the polishing pad 101 and the conductive film 66, thereby suppressing erosion. For example, the polishing pressure of about 4 psi in conventional CMP can be lowered to about 2 psi according to this embodiment.

As described above, the higher the current density, the higher the polishing rate.

As shown in FIG. 27, in the region α, i.e., in the applied voltage range of 0 to the voltage at point C, the current density increases with an increase in the voltage both when the polishing pressure is the finite value (0.5 psi) and when the polishing pressure is 0 (0 psi). On the other hand, in the region δ, i.e., in the applied voltage range of the voltage at point C to the voltage at point A, while the current density still increases with the voltage when the polishing pressure is the finite value, the current density decreases with the voltage when the polishing pressure is 0. Accordingly, a current density difference ΔIδ in the region δ between when the polishing pressure is the finite value and when the polishing pressure is 0, is always larger than a current density difference ΔIα in the region α. A difference in current density between when the polishing pressure is the finite value and when the polishing pressure is 0, virtually corresponds to a difference in polishing rate between the high portions and the low portions in the irregular surface of the conductive film. Thus, it becomes possible to produce a large difference in polishing rate between the high portions and the low portions in the irregular surface of the conductive film by carrying out polishing of the conductive film while maintaining the applied voltage in the region δ, thereby quickly eliminating the surface level difference of the conductive film.

It was also the discovery by the present inventors that the polishing rate can be controlled at any surface portion of a substrate W by regulating the electric potential at that portion. There is a difference in electric resistance between the metal films formed in the surface of the substrate, i.e., the lower barrier film 64 and the upper conductive film 66, shown in FIG. 26A. The electric potential at a particular portion of the substrate can be regulated by utilizing the difference. A voltage is applied from the second electrode (feeding electrode) 564, provided on the surface of the metal film, to that region (peripheral region) of the surface W which corresponds to the peripheral portion C4 (see FIG. 8) of the top ring 1, and an approximately uniform voltage is applied to the entire surface of the substrate W when the conductive film 66 remains over the entire substrate surface. However, the voltage distribution in the surface of the substrate W changes when the conductive film 66 is removed and part of the barrier film 64 (e.g., around the feeding electrode 654) becomes exposed, as shown in FIG. 26B.

In particular, after exposing the barrier film 64 in that region (peripheral region) of the substrate W which corresponds to the peripheral portion C4 (see FIG. 8) of the top ring 1, the conductive film 66 having a lower electric resistance than the barrier film 64 remains in the other region than the peripheral region of the substrate W. i.e., in that region of the substrate W which corresponds to the central portions C1 to C3 (see FIG. 8) of the top ring 1. The voltage comes to be applied to the conductive film 66 via the barrier film 64, whereby the voltage applied to the conductive film 66 becomes low depending on the distance from the feeding electrode 264.

In this embodiment, part of the conductive film 66 on the substrate W is first removed, thereby exposing the barrier film 64, as shown in FIG. 27B. In particular, polishing is carried out while controlling the flow rate of the pressurized fluid supplied into the pressure chambers 22 to 25 (see FIG. 7) of the top ring 1 so that the polishing pressure between the substrate W and the polishing pad 101 becomes highest in that region (peripheral region) of the substrate W which corresponds to the peripheral portion C4 (see FIG. 8) of the top ring 1. Though the distribution of polishing pressure in the other region than that region (peripheral region) of the substrate W which corresponds to the peripheral portion C4 (see FIG. 8) of the top ring 1, is preferably set such that the polishing pressure gradually increases with distance from the center of the substrate W in that region of the substrate W which corresponds to the central portions C1 to C3 (see FIG. 8) of the top ring 1, it is also possible to apply the same polishing pressure on the entire surface of the substrate W, corresponding to the peripheral portion C4 to the central portion C1 of the top ring 1.

When polishing is carried out with such a distribution of polishing pressure, polishing is promoted in that region of the substrate W which corresponds to the peripheral portion C4 of the top ring 1, i.e., the region around the feeding electrode 564, whereby the conductive film in that region is removed first. Thus, the barrier film 64 in that region of the substrate W which corresponds to the peripheral portion C4 of the top ring 1 first becomes exposed. At that point in time, the conductive film 66 remains in the other region than that region of the substrate W which corresponds to the peripheral portion C4 of the top ring 1, i.e., in that region of the substrate W which corresponds to the outer portion C3 to the central portion C1 of the top ring 1. In the case where the distribution of polishing pressure in the substrate W is set such that the polishing pressure gradually increases with distance from the center of the substrate W in that region of the substrate W which corresponds to the portions C1 to C3 of the top ring 1, the thickness of the remaining conductive film 66 decreases with distance from the center of the substrate W.

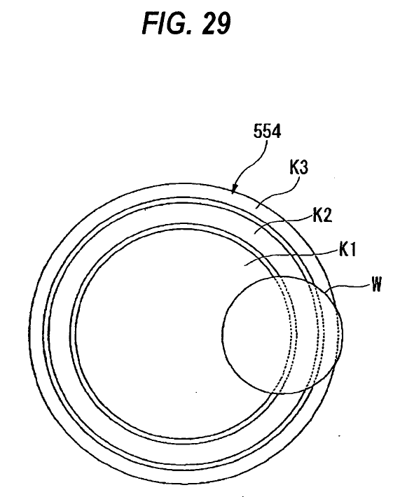

In order to remove part of the conductive film 66 from the substrate W and expose the underlying barrier film 64, it is also possible to divide a first electrode (cathode), facing the substrate W, into a plurality of small cathodes (small electrodes) and use the divided cathodes (divided electrodes). An example of such divided cathodes is cathodes K1 to K3, divided concentrically with respect to the center of a polishing table, as shown in FIG. 29. When the applied voltage between the outermost cathode (cathode K3 shown in FIG. 29) and the substrate W is made not more than the voltage at the first change point A shown in FIG. 27 and higher than the other cathodes K1, K2, the polishing rate becomes highest in that region (peripheral region) of the substrate W which corresponds to the peripheral portion C4 of the top ring 1, the substrate region facing the cathode K3 for the longest time (at the highest frequency), whereby the conductive film 66 in that region is removed first. By controlling the voltages applied to the divided cathodes such that the applied voltage gradually decreases from the outermost cathode K3 to the center cathode K1 (cathode K3>cathode K2>cathode K1 in FIG. 29), polishing proceeds with such a state of the conductive film 66 that the thickness of the remaining conductive film 66 increases from that region of the substrate W which corresponds to the outer portion C3 of the top ring 1 to that region of the substrate W which corresponds to the central portion C1 of the top ring 1, whereby the barrier film 64 becomes gradually exposed from the periphery of the substrate W. This manner of polishing is therefore preferred.

After exposing the barrier film 64, the distribution of the polishing pressure applied to the substrate W is reversed. In particular, the polishing pressure applied to that region of the substrate W which corresponds to the peripheral portion C4 of the top ring 1 is set at a low value, or at zero, while the polishing pressure applied to that region of the substrate W which corresponds to the outer portion C3 to the central portion C1 of the top ring 1 is set at a high value. Alternatively, the polishing pressure may be set at an equal value for the entire substrate surface. This can securely prevent the occurrence of erosion, caused by a mechanical polishing action, in the peripheral region of the substrate W where the barrier film 64 is exposed.

In electrochemical mechanical polishing according to this embodiment, polishing is carried out while measuring the thickness of the remaining film 66 with a film thickness sensor. An eddy current sensor is preferably used as the film thickness sensor. An eddy current sensor detects the thickness of a film by utilizing a change in synthetic impedance with a change in the thickness of the film. Measurement of the thickness of a conductive film is carried out by applying high-frequency waves to the conductive film from an eddy current sensor embedded in the polishing table 100. Thus, the use of an eddy current sensor enables high-precision measurement of a film thickness even for a thick film such as the conductive film 66.

At the point in time when the barrier film 64 has become exposed in that region (peripheral region) of the substrate W, which corresponds to the peripheral portion C4 of the top ring 1, and the voltage distribution in the substrate W has changed, the voltage applied to the feeding electrode 564 is raised. In particular, the voltage applied to that region of the substrate W, which corresponds to the peripheral portion C4 of the top ring 1, is set at a voltage which is not less than the voltage at point C, preferably not less than the voltage at point D (both see FIG. 27), so that polishing does not progress any more in the region (that region of the substrate W which corresponds to the peripheral portion C4 of the top ring 1) where the barrier film 64 has been exposed. Therefore, if the conductive film 66 for interconnects is present in that region of the substrate W which corresponds to the peripheral portion C4 of the top ring 1, dishing is less likely to occur in the surface of such conductive film.

On the other hand, in that region of the substrate W which corresponds to the central portion C1 to the outer portion C3 of the top ring 1 and in which the conductive film 66 remains on the barrier film 64, the voltage comes to be applied to the conductive film 66 via the barrier film 64 having a high resistance, whereby the voltage will decrease. However, by increasing the voltage in that region of the substrate W which corresponds to the peripheral portion C4 of the top ring 1, the decrease in the voltage can be prevented and a high current density can be maintained in that region of the substrate W which corresponds to the central portion C1 to the outer portion C3 of the top ring 1 and in which the conductive film 66 remains on the barrier film 64. In particular, the voltage applied to that region of the substrate W which corresponds to the central portion C1 to the outer portion C3 of the top ring 1, is set at a voltage which is not more than the voltage at point B shown in FIG. 27, preferably not more than the voltage at point A, especially preferably in the region δ.

Consequently, an electric current, which is around the second change voltage (voltage at point D in FIG. 27) at a polishing pressure of 0, flows in that region of the substrate W which corresponds to the peripheral portion C4 of the top ring 1, whereas an electric current, which is around the first change voltage (voltage, e.g., at point A in FIG. 27), flows in that region of the substrate W which corresponds to the central portions C1 to C3 of the top ring 1. Thus, polishing does not progress any more in the region where the barrier film 64 is exposed (that region of the substrate W which corresponds to the peripheral portion C4 of the top ring 1), whereas polishing is promoted in that region of the substrate W which corresponds to the central portions C1 to C3 of the top ring 1.

As a result, the surface conductive film, lying outside the interconnect recesses 63, is removed from the substrate W, as shown in FIG. 26C.

According to this embodiment, the current density turns into decrease when the voltage in a barrier film 64—exposed region exceeds the threshold voltage, whereby the polishing rate of the conductive film 66 becomes low. Accordingly, even when the conductive film 66, which is to become contact plugs or interconnects, is present in the barrier film 64—exposed region, dishing is less likely to occur in the surface of such conductive film 66. Further, polishing is carried out by utilizing an electrochemical dissolution action. There is, therefore, no need for the use of the conventional slurry having a high concentration of abrasive grains and, in addition, no need for high-pressure polishing. Thus, the proportion of mechanical polishing action can be lowered, thereby preventing the occurrence of erosion. Further, because of the lowered polishing pressure between the polishing pad 101 and the conductive film 66 in a barrier film 64—exposed region, the proportion of mechanical polishing action can be lowered in that region, thereby preventing the occurrence of dishing or erosion.

On the other hand, in a region where the conductive film 66 having a lower electric resistance than the barrier film 64 remains, the voltage becomes low due to a potential drop in a barrier film 64—exposed portion. Thus, such a conductive film 66—remaining region is kept at a relatively high current density as compared to the barrier film 64—exposed region. Accordingly, polishing continues to progress in the conductive film 66—remaining region. It thus becomes possible to quickly remove the conductive film while suppressing dishing as well as damage such as scratches.

By making the polishing pressure in a region around the feeding electrode 564 higher than the polishing pressure in the other region, polishing is promoted in the region around the feeding electrode 564 as compared to the other region, whereby the conductive film 66 in the former region is first removed. After the barrier film 64 has become exposed, a voltage distribution can be obtained in which the voltage applied to the metal film becomes highest in the region around the feeding electrode 564, and the voltage decreases with distance from the region. Accordingly, in the step of applying an increased voltage after the exposure of the barrier film 64, the remaining conductive film 66 can be removed with precision.

Referring to FIG. 27, the bold-line graphs indicate the relationships in the case where an electrolytic liquid is used which contains no additive for forming an electrically-insulating material, and the narrow-line graphs indicate the relationships in the case where polyethylenimine as an additive for forming an electrically insulating material is added in an amount of 1% by weight to the electrolytic liquid. The solid lines indicate the relationships in the case where the polishing pressure between a polishing pad and a substrate is 0.5 psi, and the broken lines indicate the relationships in the case where the polishing pressure is 0 psi.

As can be seen from the graphs, the current density is higher in the case where the electrolytic liquid contains no additive for forming an electrically insulating material (or contains in a low concentration). This is considered to be due to the fact that the use of a higher concentration of additive for forming an electrically insulating material forms a stronger protective film which is harder to polish away. An electrolytic liquid containing a low concentration of an additive for forming an electrically insulating material may therefore be used when a high polishing rate is desired. On the contrary, an electrolytic liquid containing a high concentration of an additive for forming an electrically insulating material may be used when a low polishing rate is desired for polishing of a thin conductive film or for accurate termination of polishing. As can also be seen from FIG. 27, the first and second change voltages are both higher in the case where the electrolytic liquid contains no additive for forming an electrically insulating material (or contains in a low concentration). It is therefore desirable to adjust the applied voltage according to the concentration of an additive for forming an electrically insulating material.

The present invention is not limited to the particular embodiments and variations described above, but various modifications could be made therein within the concept of the present invention. Thus, the particular materials, constructions, etc. described above are merely examples, and various changes could be made.

For example, though in this embodiment one second electrode (feeding electrode) is provided on a peripheral portion of a substrate, it is also possible to provide a plurality of second electrodes on a substrate. This increases contact area for voltage application and can reduce the contact resistance, enabling accurate control of an electric potential applied to a substrate. In this case, the plurality of feeding electrodes are preferably provided in a circle concentric with a substrate.

While the manner of increasing a voltage after the exposure of a barrier film has been described, it is also possible to detect a point in time immediately before the exposure of a barrier film, and increase the voltage from that point in time.

Further, a polishing pad as described below may also be used.

Examples of usable polishing pads include a closed-cell polyurethane foam and an open-cell suede pad. When an electrolytic liquid containing no abrasive grains is used, it is possible to use a fixed-abrasive pad with abrasive grains fixed by a binder. Examples of such abrasive grains include cerium oxide (CeO₂), alumina (Al₂O₃), silicon carbide (SiC), silicon oxide (SiO₂), zirconia (ZrO₂), iron oxide (FeO, FeO₂, Fe₃O₄), manganese oxide (MnO₂, Mn₂O₃), magnesium oxide (MgO), calcium oxide (CaO), barium oxide (BaO), zinc oxide (ZnO), barium carbonate (BaCO₃), calcium carbonate (CaCO₃), diamond (C), and a composite material thereof. Examples of usable binders include a phenol resin, an aminoplast resin, a polyurethane resin, an epoxy resin, an acrylic resin, an acrylated isocyanurate resin, a urea-formaldehyde resin, an isocyanurate resin, an acrylated urethane resin, an acrylated epoxy resin, etc.

A polishing pad may have grooves, such as (1) concentric circular grooves, (2) eccentric grooves, (3) polygonal grooves (including grid-like grooves), (4) helical grooves, (5) radial grooves, (6) parallel grooves, (7) arc-shaped grooves, or a combination thereof. The configuration of grooves affects holding and discharge of an electrolytic liquid. For example, concentric circular grooves or eccentric grooves have the effect of holding an electrolytic liquid on the polishing pad because of their closed flow passages. Polygonal or radial grooves, on the other hand, have the effect of promoting flowing of an electrolytic liquid to a polishing object and discharge of the electrolytic liquid out of the polishing pad. In order to enhance the efficiency of the inflow and outflow of an electrolytic liquid to and from the surface to be processed of a substrate and the efficiency of holding of the electrolytic liquid, a groove density distribution in a polishing pad may be adjusted by appropriately adjusting a groove width, a groove pitch and a groove depth in the surface of the polishing pad. For example, the width and the depth of a groove are both preferably not less than 0.4 mm, and the groove pitch is preferably at least twice the groove width. Taking the flow of an electrolytic liquid into consideration, the width and the depth of a groove are both preferably not less than 0.6 mm. Auxiliary grooves (e.g., narrow grooves formed between concentric circular grooves or narrow grooves formed between wide grid-like grooves) may also be provided for the purpose of facilitating the flow of an electrolytic liquid between the main grooves. The cross-sectional shape of a groove may be square, round or V-shaped. If it is intended to promote discharge of an electrolytic liquid from grooves, in consideration of the rotating direction of a polishing table on which a polishing pad is mounted, the grooves may be inclined in a direction opposite to the rotating direction of the polishing table. On the contrary, if it is intended to suppress discharge of an electrolytic liquid from grooves, the grooves may be inclined in the rotating direction of the polishing table. Further, it is also possible to form at least one through-hole in the surface of a polishing pad for the purpose of holding of an electrolytic liquid.

The configuration of the contact surface of a polishing pad with a substrate affects mechanical removal of a protective film formed by an electrolytic reaction. In order to increase the mechanical action of the contact surface, the contact surface preferably has a pattern of an edged shape, such as a cone, a pyramid or a prism. Depending on the polishing object, however, an edged shape can cause scratches or the like in the surface of the object. To avoid the problem, a truncated shape, such as a truncated cone or a truncated pyramid, may be used. A cylindrical, cylindroid or hemispherical shape will further reduce the mechanical action of the contact surface. The pattern of a shape as described above may be a regular pattern, such as a grid-like, zigzag or triangular pattern. Alternatively, a random pattern may be used to avoid regularity. Two or more types of shapes may be present in the polishing surface of a polishing pad. The density distribution of shapes may be adjusted.

Besides the use of an eddy current sensor as a film thickness sensor, it is also possible to measure a thickness of a film with an optical monitor or with fluorescent X-rays or by monitoring voltage/current values during polishing. The measurement with an optical sensor utilizes a change in reflection intensity due to light interference, in particular, utilizes the phenomenon that a reflected light changes with a thickness of a film after the thickness of the remaining film has reached a predetermined value. The change initiation point varies depending on the wavelength of the light used, and therefore the wavelength may be suitably selected for a material to be polished. Methods for measuring a thickness of a film with an optical sensor include a method in which a measuring light is irradiated from a light source embedded in a polishing table and passed through a through-hole of a polishing pad, and a method in which measurement is carried out on a substrate overhanging from a polishing table.

The measurement with fluorescent X-rays utilizes a change in the intensity of fluorescent X-rays, generated by irradiation of a measuring object with primary X-rays, with the thickness of the object and is carried out, during polishing, by irradiating a conductive film with primary X-rays emitted from an X-ray source embedded in a polishing table.

The measurement by monitoring voltage/current values during polishing utilizes a change in the electric resistance of a conductive film, a measuring object, with the thickness of the film. The thickness of the film is calculated from the electric resistance which is determined either by measuring a change in current at a constant voltage or by measuring a change in voltage at a constant current.

Besides the above-described detection of a thickness of a conductive film, various other methods can be used to detect completion (end point) of polishing of a conductive film, including a conductive film on a barrier film and the barrier film on an insulating film. Examples of such other methods include a method of detecting a change in the surface temperature of a polishing pad or a substrate, a method of detecting a change in the frictional force between a substrate and a polishing pad, a method of detecting a change in a surface image, a method of detecting a change in the components of a slurry or an electrolytic liquid (the concentration of a by-product oxide, the concentration of ions coming from a conductive film), etc.

For the method of detecting a change in the surface temperature of a polishing pad or a substrate, there are available a method of measuring a surface temperature of a polishing pad with a radiation thermometer and a method of measuring a surface temperature of a substrate via a through-hole provided in a polishing pad by a radiation thermometer embedded in a table.

For the method of detecting a change in the frictional force between a substrate and a polishing pad, there are available a method of detecting a change in a driving current for a polishing table on which a polishing pad is mounted or for a top ring, and a method of measuring a change with time in oscillation amplitude at a particular frequency for a top ring.

For the method of detecting a change in a surface image of a substrate, there are available a method of measuring a change in the color tone of a surface of a substrate via a through-hole provided in a polishing pad by a color sensor embedded in a polishing table, and a method of measuring a change in a two-dimensional image of a substrate surface by an image-taking device using a CCD or a CMOS.

For the method of detecting a change in the components of a slurry or an electrolytic liquid, there is available a method of measuring a change in the concentration of ions, coming from a conductive film, in a polishing liquid discharged from a polishing table.

It is also possible to control voltages applied to a barrier film 64—exposed region and a conductive film 66—remaining region by moving the position of the top ring 1 with the position of the feeding electrode 564 fixed.

The applied voltage is set a little higher (by about 0.5 V) than the voltage at point D shown in FIG. 27, and the second electrode (voltage application point) 564 as a feeding electrode is disposed in the vicinity (within 10 mm) of the circumference of the polishing table 100. Polishing of a substrate W in an initial polishing period is carried out while allowing a peripheral region of the substrate W to overhang from the polishing table 100 and, after the barrier film 64 in the peripheral region has become exposed, the top ring 1 is gradually moved in a direction away from the center of the polishing table 100, i.e., a direction of increasing the area of the overhanging portion of the substrate W During the operation, the barrier film 64—exposed region is kept in contact with the feeding electrode 564, and the conductive film 66 is made to remain in the non-overhanging region of the substrate.

By gradually moving the top ring 1 in a direction away from the center of the polishing table 100 after the barrier film 64 has become exposed, according to this embodiment, a high voltage can be maintained in the barrier film 64—exposed region. Therefore, even when the conductive film 66, which is to become contact plugs or interconnects, is present in the barrier film 64—exposed region, dishing is less likely to occur in the surface of the conductive film 66.

It is also possible to increase the voltage applied to the second electrode 564 after moving the top ring 1 so that the voltage of the barrier film 64—exposed region becomes not less than the threshold voltage (voltage at point C shown in FIG. 27).

According to this embodiment, the voltage of the region, where the barrier film 64 is exposed, can be made not less than the threshold voltage without a considerable rise of the applied voltage. Accordingly, even when the conductive film 66, which is to become contact plugs or interconnects, is present in the barrier film 64—exposed region, dishing is less likely to occur in the surface of such conductive film 66. Further, it becomes possible to securely prevent further progress of polishing in the barrier film 64—exposed region. Thus, polishing continues to progress in the conductive film 66—remaining region while polishing does not progress in the barrier film 64—exposed region. This enables quick removal of the conductive film 66 while preventing dishing and damage, such as scratches, to the substrate.

In this embodiment, the feeding electrode 564 comes into contact with approximately the entire surface of the substrate W. It is therefore preferred to use a soft material, such as a carbon resin, for the feeding electrode 564 and to bring the electrode 564 into contact with the substrate W in a scratch-free manner, such as the use of a roller that rotates by the rotation of the substrate W.

The feeding electrode 564 for voltage application is not necessarily disposed in the vicinity of the circumference of the polishing table 100. For example, it is possible to provide a feeding electrode in the shape of a concentric circle in the polishing pad 4. In this case, polishing can be carried out without overhanging of a substrate W even when the substrate W is gradually moved outwardly.

Though the case of disposing the feeding electrode 564 in the vicinity (within 10 mm) of the circumference of the polishing table 100 has been described, it is also possible to use as a second electrode (feeding electrode) a conductive pad in the shape of a concentric circle, e.g., having a width of about 1 cm, embedded in a polishing pad. If the conductive pad is disposed at a distance, which is larger than the radius of a substrate W, from the edge of the polishing table 100, polishing can be carried out stably without overhanging of the substrate even when the conductive pad has reached the center of the substrate.

According to the present invention, the voltage of a barrier film-exposed region is set so that it exceeds the threshold voltage whereby even when a conductive film, which is to become contact plugs or interconnects, is present in the barrier film-exposed region, dishing is less likely to occur in the surface of such conductive film. Further, polishing is carried out by utilizing an electrochemical dissolution action. There is, therefore, no need for the use of the conventional sluny having a high concentration of abrasive grains and, in addition, no need for high-pressure polishing. Thus, the proportion of mechanical polishing action can be lowered, thereby preventing the occurrence of erosion.

On the other hand, in a region where the conductive film having a lower electric resistance than the barrier film remains, the voltage is set so that it is higher than the threshold voltage and not more than the above-described maximum voltage, whereby a high current density can be maintained in the conductive film-remaining region until the conductive film is polished away and the substrate surface is flattened to the same level as the barrier film. Accordingly, polishing continues to progress in the conductive film-remaining region even when the conductive film which is to become contact plugs or interconnects is present. It thus becomes possible to quickly remove the conductive film and flatten the substrate surface while suppressing dishing as well as damage such as scratches.

What is claimed is:

1. An electrochemical mechanical polishing method comprising:
applying a voltage between a first electrode connected to one pole of a power source and a second electrode, connected to the other pole of the power source, for feeding electricity to a conductive film of a polishing object;
filling an electrolytic liquid into a space between the first electrode and the conductive film of the polishing object; and
pressing and rubbing the conductive film against a polishing surface of a polishing pad to polish the conductive film in such a manner that a barrier film underlying the conductive film becomes gradually exposed from the center toward the periphery of the polishing object.

2. The electrochemical mechanical polishing method according to claim 1, wherein the conductive film is polished so that the average thickness of the remaining conductive film becomes not more than 300 nm, and the thickness distribution of the remaining conductive film in the polishing object becomes not more than 150 mm.

3. The electrochemical mechanical polishing method according to claim 1, wherein the conductive film is polished so that the average thickness of the remaining conductive film becomes not more than 300 nm, and the thickness of the remaining conductive film in the polishing object increases with distance from the center toward the periphery of polishing objects.

4. The electrochemical mechanical polishing method according to claim 1, wherein polishing is carried out under such conditions that the polishing rate decreases with distance from the center toward the periphery of polishing objects.

5. The electrochemical mechanical polishing method according to claim 1, wherein when the barrier film becomes gradually exposed from the center toward the periphery of the polishing object, the electrolytic etching rate of the conductive film is not more than 50 nm/min.

6. The electrochemical mechanical polishing method according to claim 1, wherein the polishing rate of the remaining conductive film in the period of time when the average thickness of that film is not more than 200 nm, is not more than ½ of the polishing rate of the conductive film in the period of time when the average thickness of that film is not less than 200 nm.

7. The electrochemical mechanical polishing method according to claim 1, wherein two or more types of electrolytic liquids are used in the polishing of the conductive film.

8. The electrochemical mechanical polishing method according to claim 1, wherein the conductive film is composed of copper or a copper alloy, and the pH of the electrolytic liquid is in a pH range, as specified in a copper potential-pH diagram, in which a passive film is formed on copper.

9. The electrochemical mechanical polishing method according to claim 1, wherein the voltage applied between the first electrode and the second electrode when the average thickness of the remaining conductive film is not more than 200 nm, is lower than the voltage applied between the first electrode and the second electrode when the average thickness of the remaining conductive film is not less than 200 nm.

10. The electrochemical mechanical polishing method according to claim 1, wherein the voltage applied between the first electrode and the second electrode in the period from the beginning to the completion of exposure of the barrier film is not more than the corrosion potential of the conductive film in the electrode potential.

11. The electrochemical mechanical polishing method according to claim 1, wherein the waveform of the voltage applied between the first electrode and the second electrode in the period from the beginning to the completion of exposure of the barrier film is a rectangular waveform, a sine waveform, or a ramp waveform.

12. The electrochemical mechanical polishing method according to claim 1, wherein a change in a thickness of the conductive film is detected by a change in an eddy current.

13. The electrochemical mechanical polishing method according to claim 12, wherein the end point of polishing of the conductive film is detected by a change in the eddy current.

14. The electrochemical mechanical polishing method according to claim 1, wherein the end point of polishing of the conductive film is detected by a change in the electrode potential of the conductive film.

15. The electrochemical mechanical polishing method according to claim 1, wherein at least one of the flow rate distribution and the temperature distribution of the electrolytic liquid, filling the space between the first electrode and the conductive film of the polishing object, in the surface of the polishing object is controlled.

16. The electrochemical mechanical polishing method according to claim 15, wherein the flow rate distribution of the electrolytic liquid in the surface of the polishing object is controlled by independently controlling the flow rates of the flows of the electrolytic liquid, which are supplied from a plurality of electrolytic liquid supply passages, based on a difference between the thickness distribution of the conductive film during polishing and an intended thickness distribution of the conductive film.

17. The electrochemical mechanical polishing method according to claim 16, wherein the temperature distribution of the electrolytic liquid in the surface of the polishing object is controlled by independently controlling the temperatures of the flows of the electrolytic liquid, which are supplied from the plurality of electrolytic liquid supply passages, based on a difference between the thickness distribution of the conductive film during polishing and an intended thickness distribution of the conductive film.

18. The electrochemical mechanical polishing method according to claim 15, wherein the relative movement speed between the polishing pad and the polishing object is controlled.

19. An electrochemical mechanical polishing apparatus comprising:
a polishing table holding a polishing pad and having a first electrode connected to one pole of a power source;
a top ring for holding a polishing object having a conductive film, the top ring having a plurality of pressing areas for individually pressing the polishing object against a polishing surface of the polishing pad;
at least one second electrode, connected to the other pole of the power source, for feeding electricity to the conductive film of the polishing object and disposed around at least one of the outer and inner circumferences of the first electrode in an electrically-insulated state from the first electrode;
an electrolytic liquid supply section for supplying at least one type of electrolytic liquid to the polishing surface of the polishing pad;
a movement mechanism for moving the polishing object and the polishing surface relative to each other;
a detection section for detecting a signal corresponding to a thickness of the remaining conductive film; and
a control section for controlling at least one of the applied voltage of the power source, the pressure of the top ring, the flow rate of the electrolytic liquid supplied from the electrolytic liquid supply section, and the speed of said relative movement, based on a signal from the detection section.

20. The electrochemical mechanical polishing apparatus according to claim 19, wherein the first electrode is comprised of a plurality of divided electrodes which can be independently controlled by the power source.

21. The electrochemical mechanical polishing apparatus according to claim 19, wherein the second electrode is composed of a resin material having electrical conductivity.

22. The electrochemical mechanical polishing apparatus according to claim 19, wherein the electric liquid supply section has a plurality of electrolytic liquid supply passages, and the flow rates of the flows of the electrolytic liquid supplied from the electrolytic liquid supply passages can be independently controlled by the control section.

23. The electrochemical mechanical polishing apparatus according to claim 22, wherein the electrolytic liquid supply section further has a temperature control section for independently controlling the temperatures of the flows of the electrolytic liquid flowing along the plurality of electrolytic liquid supply passages.

24. The electrochemical mechanical polishing apparatus according to claim 19, wherein the detection section is an eddy current sensor.

25. The electrochemical mechanical polishing apparatus according to claim 19, wherein the detection section is a reference electrode for detecting a change in the electrode potential of the conductive film.

26. The electrochemical mechanical polishing apparatus according to claim 19, wherein the control section controls polishing of the conductive film so that a barrier film underlying the conductive film becomes gradually exposed from the center toward the periphery of the polishing object.

27. An electrochemical mechanical polishing method comprising:
applying a voltage between a first electrode connected to one pole of a power source and a second electrode, connected to the other pole of the power source, for feeding electricity to a conductive film of a polishing object;
filling an electrolytic liquid into a space between the first electrode and the conductive film of the polishing object; and
pressing and rubbing the conductive film against a polishing surface of a polishing pad to polish the conductive film and expose a barrier film underlying the conductive film;
wherein immediately before the exposure of the barrier film, an electrolytic liquid is used which forms a passive film, which makes the polishing rate of the conductive film not more than 50 nm/min, in the surface of the conductive film.

28. The electrochemical mechanical polishing method according to claim 27, wherein when the electrolytic liquid is supplied, the voltage applied between the first electrode and the second electrode is adjusted in a voltage range which corresponds to a range of electrode potential in which the passive film is formed on the surface of the conductive film.

29. An electrochemical mechanical polishing method comprising:
bringing an electrolytic liquid having a pH of 4 to 10 into contact with a metal film composed of a conductive film, formed in a surface of a polishing object, and a barrier film underlying the conductive film;
moving the polishing object and a polishing pad relative to each other while applying a first voltage to the metal film and pressing a surface of the polishing object against the polishing pad at a predetermined polishing pressure, thereby first removing the conductive film around a voltage application point from which said voltage is applied and exposing the barrier film underlying the conductive film; and
applying a second voltage, which is higher than the first voltage, to the metal film immediately before or after the exposure of the barrier film, thereby removing the conductive film, the second voltage being such as to make the voltage in a region where the barrier film is exposed higher than a threshold voltage, the threshold voltage being a voltage at which the current density turns from increase into decrease when said voltage is increased while moving the polishing object and the polishing pad relative to each other at a polishing pressure of 0.

30. The electrochemical mechanical polishing method according to claim 29, wherein the second voltage is a voltage which makes the voltage in the other region than said barrier film-exposed region higher than said threshold voltage and not more than a maximum voltage, the maximum voltage being a voltage at which the current density turns from decrease after increase into constancy as said voltage is increased when said polishing pressure is a finite value.

31. The electrochemical mechanical polishing method according to claim 29, wherein in the step of exposing the barrier film, the polishing pressure between the polishing object and the polishing pad in a region around the voltage application point is made higher than the polishing pressure in the other region than the region around the voltage application point.

32. The electrochemical mechanical polishing method according to claim 29, wherein a counter electrode is used which faces the polishing object and is comprised of a plurality of small divided electrodes arranged concentrically on the same plane, and in the step of exposing the barrier film, the voltages of the divided electrodes are controlled so that the polishing rate increases with the frequency of each divided electrode facing the periphery of the polishing object.

33. The electrochemical mechanical polishing method according to claim 29, wherein polishing of the conductive film is carried out while measuring the thickness of the remaining conductive film by an eddy current method.

34. The electrochemical mechanical polishing method according to claim 29, wherein the conductive film is a tungsten film.

35. An electrochemical mechanical polishing method comprising:
bringing an electrolytic liquid having a pH of 4 to 10 into contact with a metal film composed of a conductive film, formed in a surface of a polishing object, and a barrier film underlying the conductive film;
moving the polishing object and a polishing pad relative to each other while applying a voltage to the metal film from a voltage application point disposed on a peripheral portion of the polishing object and pressing a surface of the polishing object against the polishing pad at a predetermined polishing pressure, thereby first removing the conductive film around the voltage application point and exposing the barrier film underlying the conductive film; and then
moving the voltage application point from the peripheral portion to the center of the polishing object, thereby further exposing the barrier film.

36. An electrochemical mechanical polishing method comprising:
bringing an electrolytic liquid having a pH of 4 to 10 into contact with a metal film composed of a conductive film, formed in a surface of a polishing object, and a barrier film underlying the conductive film;
moving the polishing object and a polishing pad relative to each other while applying a voltage to the metal film from a voltage application point disposed on a peripheral portion of the polishing object and pressing a surface of the polishing object against the polishing pad at a predetermined polishing pressure, thereby first removing the conductive film around the voltage application point and exposing the barrier film underlying the conductive film;
moving the voltage application point from the peripheral portion to the center of the polishing object, thereby further exposing the barrier film; and
applying a second voltage, which is higher than the first voltage, to the metal film immediately before or after the exposure of the barrier film, thereby removing the conductive film, the second voltage being such as to make the voltage in a region where the barrier film is exposed higher than a threshold voltage, the threshold voltage being a voltage at which the current density turns from increase into decrease when said voltage is increased while moving the polishing object and the polishing pad relative to each other at a polishing pressure of 0.
